(19) United States
(12) Patent Application Publication
(10) Pub. No.: US 2026/0049926 A1
(43) Pub. Date: Feb. 19, 2026

(54) SYSTEMS, DEVICES AND METHODS FOR SORTING MOVING PARTICLES

(71) Applicant: The Regents of the University of California, Oakland, CA (US)

(72) Inventors: Rui TANG, San Diego, CA (US); Zunming ZHANG, San Diego, CA (US); Yu-Hwa LO, San Diego, CA (US)

(21) Appl. No.: 19/170,625

(22) Filed: Apr. 4, 2025

Related U.S. Application Data
(63) Continuation of application No. PCT/US2023/076279, filed on Oct. 6, 2023.
(60) Provisional application No. 63/378,639, filed on Oct. 6, 2022.

(51) Int. Cl. G01N 15/149; G01N 15/1434

(52) U.S. Cl. CPC G01N 15/149; G01N 15/1434

(57) ABSTRACT

Systems, devices and methods for sorting particles utilizing focus stacking of two-dimensional images are described. Such systems, devices and methods may further provide for particle processing and may encompass, on a microfluidic scale, sample enrichment, sample mixing, sample/particle sorting, verification of sorting and feedback-based optical sorting.

### CROSS-REFERENCE TO RELATED APPLICATIONS

This application is a continuation of International Patent Application No. PCT/US2023/076279, filed Oct. 6, 2023, which claims the benefit of U.S. Provisional Patent Application No. 63/378,639, filed Oct. 6, 2022, each of which is incorporated by reference in its entirety.

### STATEMENT AS TO FEDERALLY SPONSORED RESEARCH

This disclosure was made with government support by NIH under grant number 2R44DA045460-02. The government has certain rights under the disclosure.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Flow cytometry may be used for detecting and analyze particles, such as living cells. For example, a flow cytometer device may be used to characterize physical and biochemical properties of cells and/or biochemical molecules or molecule clusters based on their optical, electrical, acoustic, and/or magnetic responses as they are interrogated by in a serial manner. Typically, flow cytometry uses an external light source to interrogate the particles, from which optical signals are detected. Such signals may be caused by one or more interactions between the input light and the particles. Types of light signals can be forward scattering, side scattering, and fluorescence. Properties measured by flow cytometry may include a particle's relative size, granularity, and/or fluorescence intensity. Devices such as flow cytometers and cell sorters, and particularly those based on fluorescence activated cell sorting (FACS), are utilized for biomedical research and applications.

### SUMMARY

Described herein are various embodiments of a system for sorting a particle in a sample comprising: a flow cell configured to allow the particle to move in a flow path in a flow direction; a sorting module fluidly connected to the flow cell; an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; a detection module comprising at least one spatial filter, the at least one spatial filter comprising a forward spatial filter and the at least one spatial filter comprises: a front surface; a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and a data processing module configured to generate a gating signal using the time-dependent signal, and wherein the sorting module is configured to receive the gating signal and sort the particle in response to the gating signal. In some embodiments, a plurality of focal planes corresponds to the plurality of apertures. In some embodiments, at least a subset of the plurality of focal planes reside within the flow path. In some embodiments, the forward spatial filter is configured for transmission detection. In some embodiments, each of the plurality of focal planes are orthogonal to the light propagating direction. In some embodiments, each of the focal planes are offset to each other along the light propagating direction. In some embodiments, the tilting angle of the forward spatial filter, θ, is about 20 degrees to about 60 degrees. In some embodiments, the at least one spatial filter comprises a side detection spatial filter. In some embodiments, each of the plurality of focal planes are orthogonal to a secondary light propagating direction and offset to each other along the secondary light propagating direction. In some embodiments, the light propagating direction and the secondary light propagating direction are perpendicular to each other. In some embodiments, the tilting angle of the side spatial filter, ϑ, is about 2 degrees to about 15 degrees. In some embodiments, a particle motion device comprising a flow cell, the particle motion device configured to move a sample fluid along the flow path in the flow direction, the flow path surrounded by a sheath flow. In some embodiments, the particle comprises a plurality of particles. In some embodiments, the particle feature comprises a plurality of particle features. In some embodiments, the particle feature comprises a region on or within the particle. In some embodiments, the region on or within the particle comprises a plurality of regions on or within the particle. In some embodiments, a first particle feature of the plurality of particle features comprises a first region of the plurality of regions on or within the particle. In some embodiments, a second particle feature of the plurality of particle features comprises a second region of the plurality of regions on or within the particle. In some embodiments, the time-dependent signal comprises a plurality of time-dependent signal features. In some embodiments, the time-dependent signal comprises a first time-dependent signal feature of the plurality. In some embodiments, the time-dependent signal comprises a second time-dependent signal feature of the plurality. In some embodiments, the first time-dependent signal feature correlates to the first particle feature, the second particle feature or a combination thereof. In some embodiments, the second time-dependent signal feature correlates to the first particle feature, the second particle feature or a combination thereof. In some embodiments, the particle comprises a cell. In some embodiments, the particle feature comprises an organelle, a partial organelle, or a plurality of organelles of the cell. In some embodiments, the cell is a gamma radiation damaged cell with histone related staining. In some embodiments, the light redirecting device comprises an acoustic optical deflector. In some embodiments, the illumination module further comprises a light source, an excitation filter, a cylindrical lens, or a combination thereof. In some embodiments, the light source, the cylindrical lens and the flow cell are offset along the light propagating direction, wherein the cylindrical lens is positioned between the light source and the flow cell. In some embodiments, the light source comprises a plurality of light sources. In some embodiments, the cylindrical lens and the flow cell are offset along the light propagating direction. In some embodiments, the cylindrical lens is configured to elongate the light beam within the plane comprising the scanning direction and the flow direction, the elongated light beam comprising a light sheet. In some embodiments, the scan comprises a plurality of light sheet positions offset along the light propagating direction. In some embodiments, the time-dependent signal comprises a plurality of time-dependent signals. In some embodiments, the time-dependent signal comprises at least one aperture-line-scan-time-dependent signal. In some embodiments, the aperture-line-scan-time-dependent signal comprises a light-intensity-time point. In some embodiments, the at least one aperture-line-scan-time-dependent signal is acquired via a single aperture. In some embodiments, the aperture-line-scan-time-dependent signal comprises a 1-dimensional (1D) profile of the particle. In some embodiments, the time-dependent signal comprises a 2D profile of the particle. In some embodiments, the time-dependent signal comprises a 3D profile of the particle. In some embodiments, the at least one light source comprises at least one laser, or at least one broadband light source, or a combination thereof. In some embodiments, the at least one laser comprises a wavelength of about 488 nanometers. In some embodiments, the broadband light source may comprise a halogen source, a Xenon source, light emitting diode (LED) source, or a combination thereof. In some embodiments, the detector comprises a plurality of detectors. In some embodiments, the detector comprises a PMT, APD, CCD, or photodiode detector. In some embodiments, the time-dependent signal comprises data correlating to the different features of the particle in relation to 3D space. In some embodiments, the data processing module is configured to generate 2D image slices of the particle, the 2D image comprising the different features of the particle. In some embodiments, the data processing module is configured to generate a 3D image of the particle, the 3D image comprising the different features of the particle. In some embodiments, the spatial filter is an optical fiber bundle comprising a plurality of optical fibers. In some embodiments, the aperture comprises a core of an optical fiber of an optical fiber bundle. In some embodiments, the flow cell comprises quartz. In some embodiments, the flow cell comprises a polymer, such as polydimethylsiloxane (PDMS) or cyclic olefin copolymers (COC). In some embodiments, the flow cell exhibits a low autofluorescence. In some embodiments, the system further comprises a dielectric mirror configured to elongate the laser beam. In some embodiments, the detection module comprises a focal depth of about 5 microns to about 70 microns. In some embodiments, the detection module comprises a focal depth of about 100 microns. In some embodiments, at least the illumination module, the detection module, the data processing module, or a combination thereof is configured for forward (e.g., transmission) detection. In some embodiments, at least the illumination module, the detection module, the data processing module, or a combination thereof is configured for side detection. In some embodiments, at least the illumination module, the detection module, the data processing module, or a combination thereof is configured for fluorescence detection. In some embodiments, the flow cell comprises an outer surface, wherein the outer surface comprises at least one region that is orthogonal to light scattered by the particle. In some embodiments, the side scatter detector is configured to detect the light scattered by the particle at a side scatter detection angle from about 70 degrees to about 110 degrees. In some embodiments, the flow cell comprises a cross fitting configured to generate the sheath flow. In some embodiments, the flow cell is configured for 2D hydrodynamic focusing. In some embodiments, the flow cell comprises an inner diameter of about 200 microns. In some embodiments, the flow cell comprises a cone tapered end. In some embodiments, the cone tapered end has an inner diameter of about 250 microns. In some embodiments, the illumination module comprises a digitizer. In some embodiments, the illumination module comprises 12 output channels. In some embodiments, the 12 output channels comprise 11 PMT channels and 1 AOD channel. In some embodiments, data is transmitted with a field programmable gate array (FPGA) into PXIe-BUS. In some embodiments, the data processing module comprises a data processing pipeline, the pipeline configured to: obtain time-dependent data; parse time-dependent data; generate intensity statistics; and determine a gating. In some embodiments, the sorting module is configured for jet-in-air sorting. In some embodiments, the sorting module is configured for laser cavitation sorting. In some embodiments, the system is configured to sort at least about 10⁻⁴ seconds after the detection of the particle. In some embodiments, the system is configured to sort from about 10⁻⁴ seconds to about 10⁻¹ seconds after the detection of the particle. In some embodiments, the detection module is configured for imaging flow cytometry. In some embodiments, the detection module is configured for three-dimensional imaging flow cytometry. In some embodiments, the detection module is configured for two-dimensional transmission imaging flow cytometry. In some embodiments, the system further comprises at least two output channels, each output channel fluidly connected to the sorting module, wherein the sorting module is configured to receive the gating signal and sort the particle, into one of the at least two output channels. In some embodiments, the illumination module comprising a light redirection device is configured to scan a light beam in a scanning direction, wherein the scanning direction is within about ±10 degrees to a perpendicular orientation with the flow direction, and wherein the light beam is propagated in a light propagating direction within about ±10 degrees to an orthogonal orientation to a plane comprising the flow direction and the scanning direction.

Described herein are various embodiments of a method for particle sorting, the method comprising: providing a sorting system comprising: a flow cell configured to allow a particle to move in a flow path in a flow direction; a sorting module fluidly connected to the flow cell; an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; a detection module comprising a spatial filter, the spatial filter comprising: a front surface; a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and a data processing module configured to generate a gating signal using the time-dependent signal; and loading a sample comprising the plurality of particles into the system; and initiating the system, and wherein, the sorting module is configured to sort the particle in response the gating signal.

Described herein are various embodiments, of a method for cell sorting, the method comprising: flowing a particle along a flow path through a flow cell in a flow direction; illuminating the particle via scanning a light beam in a scanning direction, the scanning direction about perpendicular to the flow direction, the light beam propagating in a light propagating direction about orthogonal to a plane comprising the flow direction and the scanning direction; detecting the particle, wherein light having interacted with the particle transmits through an aperture of a plurality of apertures of a spatial filter, the plurality of apertures arranged in a line comprising a tilting angle with the flow direction, wherein the detection module is configured to generate a time-dependent signal upon detection of the particle, wherein the time-dependent signal correlates to a particle feature of the particle; generating a gating signal based on aspects of the particle feature; and sorting the particle based on the gating signal.

Described herein are various embodiments of an automated data processing method for flow cytometry gating, the method comprising: obtaining a time-dependent signal; generating intensity statistics; and determining a gating signal. In some embodiments, the method further comprises parsing the time-dependent signal.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 depicts a diagram of an imaging flow cytometry system, including a schematic of a side detection spatial filter (SP) and a schematic of corresponding focal planes intersecting a particle at different timepoints as it moves along the direction of flow (Y-axis) in accordance with some embodiments.

FIG. 2 shows an image of a system, in accordance with some embodiments.

FIG. 3 shows the temporal spatial transformation relationship, as measured by detector voltage versus time as the particle is scanned via an acoustic optical deflector (AOD) driven laser in accordance with some embodiments.

FIG. 4 shows a voltage vs time signal for the time frame that the cell travels from one pinhole to the next, 100 microseconds for example, multiple (20 in this case) periods of laser scanning are performed, and a 2D image stack is recovered from the PMT readout in accordance with some embodiments.

FIG. 5 shows a particles 3D profile in xyz space, in accordance with some embodiments.

FIGS. 6A-6B depict overview and cross-section schematics for the flow focusing system including the flow cell and cross assembly connector in accordance with some embodiments.

FIGS. 7A-7B depict cross sectional and top views of the cross-assembly connector in accordance with some embodiments.

FIG. 8 depicts a plot of sample flow width versus sample flow rate, thus providing 2D hydrodynamic flow confinement performance in accordance with some embodiments.

FIG. 9 shows a schematic of the real-time data acquisition system in accordance with some embodiments.

FIG. 10 shows a diagram of a data processing algorithm in accordance with some embodiments.

FIG. 11 shows a flow chart depicting the process for extracting features (e.g., particles, particle features, cells, etc . . . ) from image slices in accordance with some embodiments.

FIGS. 12A-12E show 3D IFC imaging experiment results in accordance with some embodiments.

FIGS. 13A-13D show 3D IFC imaging experiment results in accordance with some embodiments.

FIG. 14 shows a block diagram of an embodiment of a system incorporating 3D-IFC and two-dimensional transmission (e.g., forward) detection imaging flow cytometry (2D-IFC) in accordance with some embodiments.

FIG. 15 shows a block diagram of an example system incorporating 3D-IFC and 2D-IFC detection in accordance with some embodiments.

FIG. 16A-16B show a spatial filter with a diagonal arrangement of pinholes and a schematic of corresponding focal planes intersecting a particle a different timepoints while traveling along the axis of flow, respectively in accordance with some embodiments.

FIGS. 17A-17B provide dimension parameters for the side spatial filter (SP) and the forward spatial filter (FSP) in accordance with some embodiments.

FIG. 18 provides temporal spatial transformation data and corresponding images for side detection and transmission data in accordance with some embodiments.

FIG. 19A provides a front view of the forward spatial filter (FSP), in accordance with some embodiments. FIG. 19B provides a side view diagram for 2D-IFC detection system in accordance with some embodiments.

FIG. 20 provides a ray tracing diagram for 2D-IFC detection system in accordance with some embodiments.

FIG. 21 shows a plot providing the calculated value of the forward spatial filter (FSP) tilting angle, θ, in accordance with some embodiments.

FIGS. 22A-22H provide 2D transmission images of a cell at different focal planes in accordance with some embodiments.

FIGS. 23A-23H provide zoomed-in images of a cell at different focal planes in accordance with some embodiments. FIG. 23I provides a color map composite image. FIG. 23J provides a focus staked composite image of the images provided in FIGS. 23A-23H in accordance with some embodiments.

FIGS. 24A-24H provide 2D transmission images of a cell (different from the cell of FIGS. 22-23) at different focal plane in accordance with some embodiments.

FIGS. 25A-25H provide zoomed-in images of a cell (different from the cell of FIGS. 22-23) at different focal planes according to some embodiments. FIG. 25I provides a color map composite image. FIG. 25J provides a focus staked composite image of the images provided in FIGS. 25A-25H, in accordance with some embodiments.

FIG. 26A provides a schematic for a jet-in-air-based sorting system in accordance with some embodiments. FIG. 26B provides a close-up schematic of the illumination detection system of FIG. 26A in accordance with some embodiments.

FIG. 27 provides a schematic for a laser cavitation-based sorting system in accordance with some embodiments.

FIGS. 28A-28B provide schematics for a laser cavitation-based sorting system in accordance with some embodiments.

FIG. 29 provides a schematic for an acoustic-based sorting system in accordance with some embodiments.

FIGS. 30A-30B provide schematics for an acoustic-based sorting system in accordance with some embodiments.

FIG. 31 provides wavelength parameters for acoustic sorting in accordance with some embodiments.

FIGS. 32A-32C provide schematics of the forward (e.g., transmission) spatial filter and the side detection spatial filter as well as the relative positioning of the filters within the system in accordance with some embodiments.

FIG. 33 provides an optical schematic for image flow cytometer epi-fluorescence configuration in accordance with some embodiments.

FIG. 34 provides a schematic optomechanical layout for an image flow cytometer epi-fluorescence configuration in accordance with some embodiments.

FIGS. 35A-35C provide schematics for brightfield and darkfield spatial filter and customized donut mirror design in accordance with some embodiments. FIG. 35A provides a schematic of a brightfield spatial filter design. FIG. 35B provides a schematic of a darkfield spatial filter design. FIG. 35C provides a schematic of a customized donut mirror design.

FIGS. 36A-36B provide imaging data from an epi-fluorescence configuration in accordance with some embodiments.

### DETAILED DESCRIPTION

### Introduction

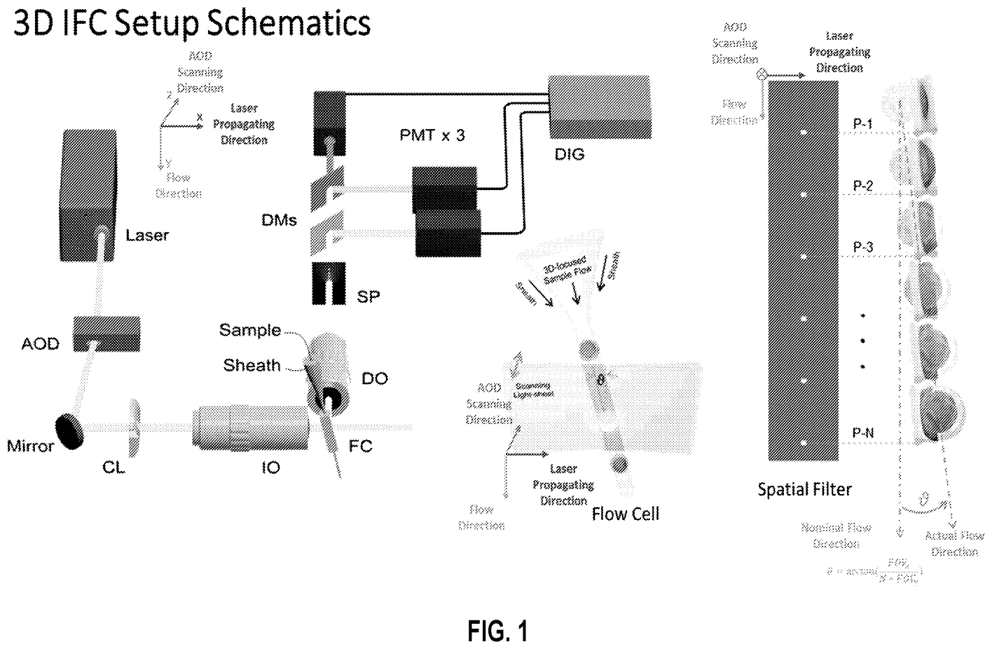

Some embodiments disclosed herein are operable for interrogation and sorting of single particles to determine particle characteristics and to sort (e.g., isolate or concentrate) particles with particular characteristics for follow-up analyses, for example. Embodiments disclosed herein are operable to perform this function while reducing the size, cost, and complexity of manufacture and/or operation associated with prior art systems. FIG. 1 illustrates an exemplary embodiment of the modular nature of a particle analyzer and sorter of the present disclosure. With reference to cell sorting, embodiments disclosed herein may serve the growing needs for isolation of selected cell subpopulations based on the optical detection of cell properties and/or biological markers. Such embodiments are described in U.S. Pat. No. 10,816,550 which is incorporated herein by reference in its entirety.

Often, mass spectrometry approaches are only suitable for proteins/peptides. One known optical approach includes a flow cytometry platform that uses a “two-color code” with fluorescent microparticles linked to antibodies combined with a different fluorophore attached to another antibody per analyte. However, such a dual-color code approach requires multiple lasers and optical detectors that make the system bulky and expensive. This is a major drawback that results in a large footprint and high cost of instrumentation.

Additionally, embodiments disclosed herein provide complete systems for particle processing and may encompass, on a microfluidic scale, sample enrichment (e.g., via spiral enrichment structures, described later), sample mixing (e.g., via serpentine mixing structures, described later), sample/particle sorting (e.g., via optical-based particle sorters, acoustic sorters, laser activation sorters, jet-in-air sorters, and piezoelectric actuation), verification of sorting (e.g., via impedance-based sensors), feedback-based optical sorting (e.g., via hybrid optical/impedance based systems). Embodiments described herein may further provide integrated reagent supplies and mixing with samples (e.g., on-chip reagents for pre-sort/post-sort mixing). Embodiments described herein may further provide for optimizing sorted particle collection volumes (e.g., the use of post-sort valves).

Embodiments described herein further provide optical systems and improved methods for particle detection (e.g., the COST method). Exemplary embodiments described herein further provide for improved systems for particle detection that may include color compensation (e.g., when a particle fluoresces at two or more wavelengths) as well as approaches for improving dynamic range in single detector systems.

As a non-limiting example, a sample enrichment structure may receive a sample (e.g, blood) and provide an enriched sample as input to a mixing structure for adding reagents to the enriched sample (e.g., fluorescent markers), from (in some embodiments) an on-chip reagent supply, for example. The mixing structure may provide the sample mixture containing particles to be sorted to the input port of a source channel. An optical detection mechanism (e.g., the COST setup/method as disclosed herein) may detect the particles, and a sorting mechanism may sort the particles based on the optical detection mechanism. A verification mechanism may ensure the particle was properly sorted and may be used to provide feedback to the sorting mechanism.

In some embodiments, the optical detection mechanism may account for color compensation, and/or may be configured for increasing the dynamic range of a single detector associated therewith. In some embodiments, a post-sort mechanism (e.g., a valve) may be formed in each destination channel to control the volume associated with the sorted particle, based on timing information received from the verification mechanism.

Systems, apparatus, and methods for sorting particles are described herein. In some embodiments, a particle is sorted from a first channel into one of several second channels based on optical characteristics of the particle, as measured by a first detection signal. In some embodiments, the sorting of the particle into the second channel is verified by a second detection signal associated with the presence and/or volume of the particle in the second channel. Aspects of this disclosure hence enable verifying that the optical characteristics of the particle were correctly identified that the number of particles sorted into each sorting channel was correct, that the particle was correctly sorted, and/or the like. Aspects of this disclosure are further operable to use the verification information for further analysis, such as for feedback control of the sorting, for characterizing the sorted particles, and/or the like.

Circulating tumor cells (CTCs) that may invade, colonize, and proliferate in distant sites may be considered as markers for the metastatic malignancy of a given tumor. CTCs collected from peripheral blood or bone marrow hold the promise as “liquid biopsy” to biologically characterize the patient's cancer at the DNA, mRNA, and/or protein level. In conjunction with enumeration of CTCs, such analysis at the molecular level may reveal important information about the nature of metastatic disease, diagnosis and prognosis of a neoplasm, progression of treatment, and development of the most effective, personalized cancer therapy (e.g., chemotherapy).

Flow cytometry (or FACS) may allow for rapid, highly specific, quantitative cell-by-cell analysis by multiple parameters, as well as the ability to sort CTCs for further molecular characterization. Additionally, flow cytometry is a mature, well-recognized, and commercially viable technology. However, several obstacles make current flow cytometers impractical for point-of-care analysis of CTCs due to their complexity, size, and high costs. Provided here, in some embodiments, is a microfluidic technology that allows for the detection and/or capture of specific cell types/subpopulations (e.g., CTCs) in a composition of a plurality of cell types using, in some embodiments, a closed disposable chip ideal for clinical applications because of reduced risk of contamination and/or carryover.

In some embodiments, a micro cell detection system is described herein includinga lab-on-a-chip microfluidic detector that may provide on-chip antibody labeling, enumeration, and sorting of cell populations (e.g., CTCs) suitable for downstream molecular analysis. In some embodiments, a micro cell detection system including a lab-on-a-chip microfluidic detector may provide sorting, detection and/or collection of live (e.g., viable) cell populations, and/or cell subpopulations (e.g., relatively abundant cell types, relatively rare cell types, specific cell types such as CTCs, and/or the like). In some embodiments, a micro cell detection system may include (i) an enrichment structure, (ii) a mixing structure, and (iii) a microfluidic detector. In some embodiments, a cell detection system includes (i) a first-stage cell separation/cell enricher, (ii) a fluid-dynamic assisted mixer and (iii) a bench-top micro-FACS (e.g., a microfluidic detector) for cell isolation.

In some embodiments, a detector system described herein may be a cost-effective, easy-to-use, rapid, and reliable technology and methodology to (1) enumerate (e.g., enrich) and (2) isolate cell subpopulations (e.g., relatively rare cell types/rare cell populations, e.g., CTCs) from whole blood. Detector systems described herein have advantages over conventional FACS systems that are 5-10 times more expensive, complicated to use, and are very large. In some embodiments, a detector system may provide for (1) enrichment of a cell population (e.g., specific cell types, CTCs) by about 100-fold or more (e.g., about 400-fold) utilizing an enrichment structure, (2) labeling of an enriched cell type or enriched cell population with a binding agent (e.g., an antibody) in less than 2 minutes using a mixing structure, and (3) detecting and/or isolating a labeled cell with a recovery rate of about 28% or greater, or about 30% or greater, or about 40% or greater, or from about 28% to about 90%, or from about 28% to about 80%, or from about 28% to about 70%, or from about 28% to about 60%.

A central challenge of biology is to correlate the phenotype of heterogeneous individuals in a population to their genotype to understand the extent to which they conform to the observed population behavior or stand out as exceptions that drive disease or the ability to become threats to health. While optical microscopy has been a cornerstone method to study the morphology and molecular composition of biological specimens, flow cytometry has been used for quantitative high-throughput single-cell characterization in numerous biomedical applications. Conventional imaging flow cytometry (IFC) is a technique that merges some aspects of optical imaging with flow cytometry. For example, IFC may simultaneously produce ensemble-averaged measurements and high-content spatial metrics from individual cells in a large population of cells, without perturbation due to experiment condition change.

Methods, devices, systems, and applications for camera-less, high-throughput three-dimensional imaging of particles in motion utilizing 3D-IFC have been developed to address this problem. Such systems are described in detail in PCT Publication No. WO 2019161406 A1 herein incorporated by reference in its entirety.

FIG. 1 shows a block diagram of an example embodiment of a three-dimensional imaging flow cytometry (3D-IFC) system in accordance with the present technology. In some embodiments, a light source (e.g., laser beam) may be configured to scan along one direction of the object plane. In some embodiments, laser scanning may be achieved by passing the laser beam through an acoustic optical deflector (AOD). In some embodiments, an acoustic optical deflector may control the diffraction angle of the laser beam based on a modulated input signal. In some embodiments, a cylindrical lens may be used to create a light sheet to change the beam shape. In certain examples, a spatial filter may be used to block out-of-focus light. In some embodiments, the scattered light passes through a dichroic mirror and at least one bandpass filter to achieve multi-spectral signal recording. In some examples, the sheath and sample flow feed directly to a flow cell cuvette to achieve 3D hydrodynamic focusing. In some examples, the slits on the spatial filter are placed vertically and the flow cell is tilted with a small angle. In such an embodiment, as the cell flow through each slit, the slit will slice cell with different depth along the laser propagating direction (Z-axis), as shown in FIG. 1. FIG. 1 also shows an example schematic of a side detection spatial filter (SP) and a schematic of corresponding focal planes intersecting a particle at different timepoints as it moves along the axis of flow, enabling scanning along the laser propagation axis. As depicted in FIG. 1, the actual direction of flow (e.g., Y-axis) is set at a tilt angle, [symbol] , relative to the nominal direction of flow (Y-axis), in accordance with some embodiments. In such embodiments, the flow cell may be tilted relative to. In some embodiments, the flow cell is not tilted (e.g., [symbol] =0°) and the actual flow direction matches nominal flow direction. Instead, the array of apertures (e.g., pinhole or slit) in the spatial filter is arranged with an angle [symbol] with respect to the vertical axis in parallel with the flow direction.

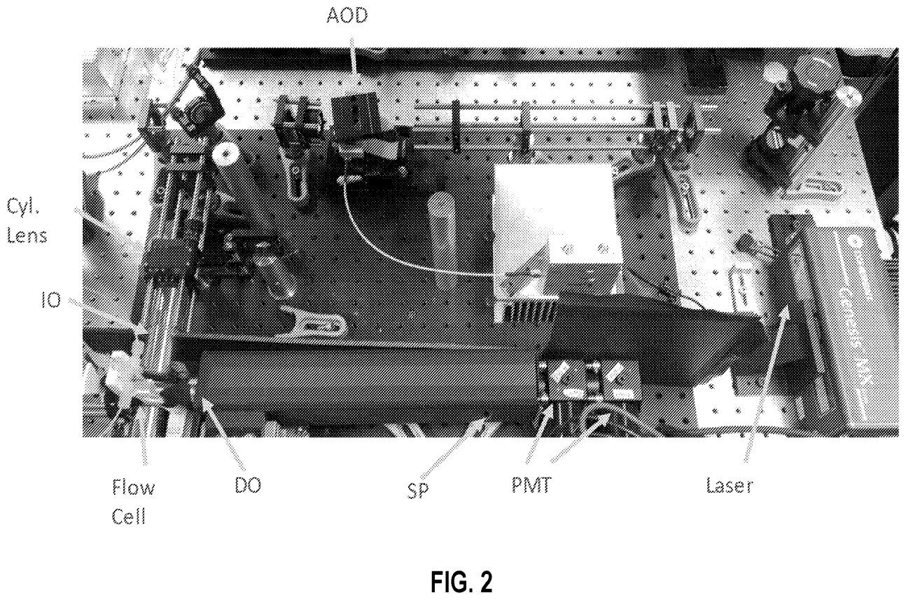

FIG. 2 shows an image of a system in accordance with some embodiments. In some embodiments, the system comprises an acoustic optical deflector (AOD), a cylindrical lens (e.g., cyl. lens), an illumination objective (e.g., IO), a flow cell, a detection objective (DO), a spatial filter (SP), a photomultiplier tube (PMT) and a laser.

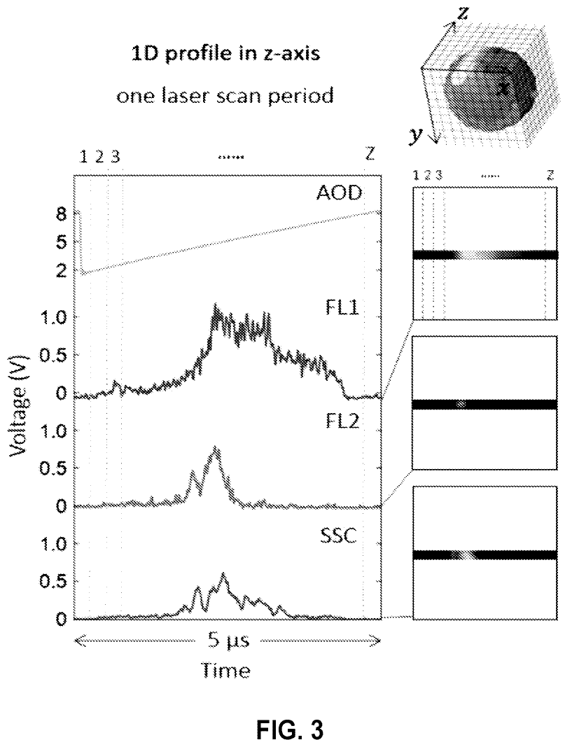

FIG. 3 shows the temporal spatial transformation relationship that is measured by detector voltage versus time, where the particle (e.g., cell) may be scanned by the AOD, in accordance with some embodiments. The laser may be scanned at 200 kHz. For such embodiments, a one-dimensional (1D) intensity profile in z-axis may be recovered from the time-domain signal within 5 μs.

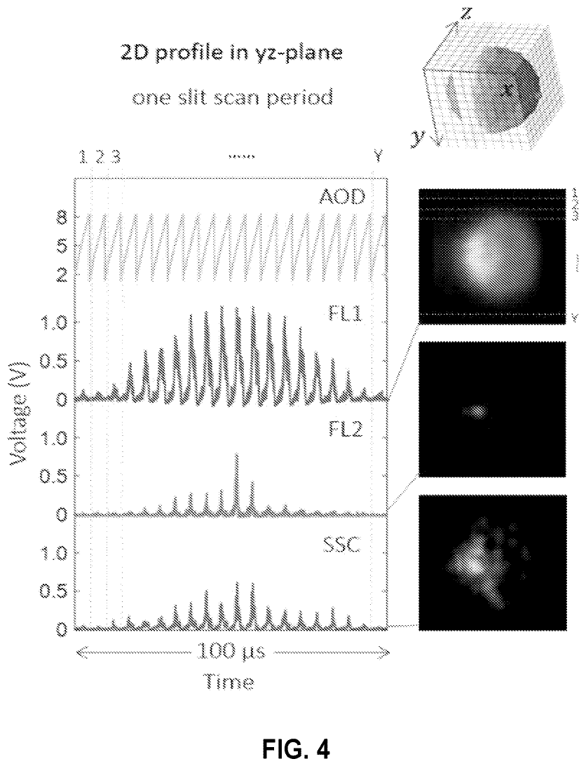

FIG. 4 shows voltage vs time signal for the time frame that the particle (e.g., cell) travels from one aperture (e.g., pinhole or slit) on the spatial filter to the next. In some embodiments, the time that the particle (e.g., cell) travels from one aperture (e.g., pinhole or slit) to the next may be 100 μs. In some embodiments, multiple periods of laser scanning may be performed. In some embodiments, as depicted in FIG. 4, 20 periods of laser scanning may be performed. In some embodiments, a 2D image stack may be recovered from the PMT readout. In some embodiments, the stack of 2D images can be used to construct a 3D image of the particle, or one or multiple 2D images from the stack can be used to analyze the particle properties.

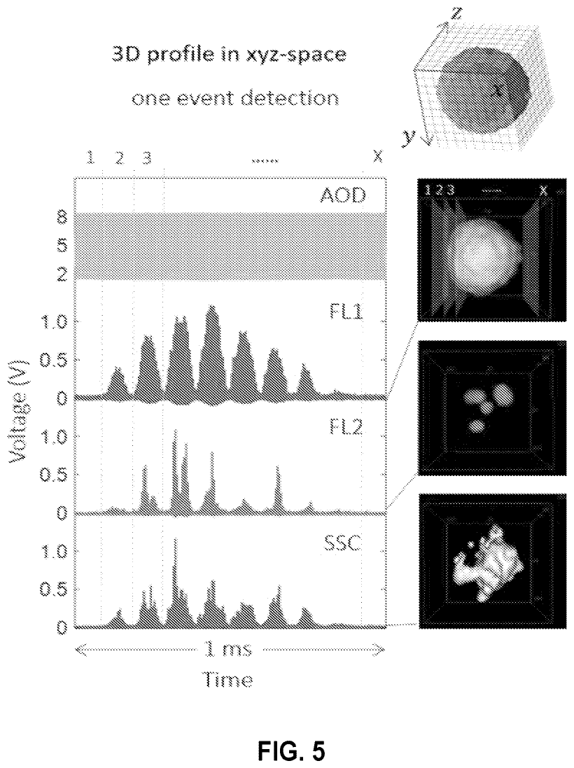

FIG. 5 demonstrates that the number of aperture (e.g., pinhole or slit)s reveal the voxel's x-position. As the particle (e.g., cell) travels through the entire interrogation area-passes the last aperture (e.g., pinhole or slit), 2D image stacks are recovered, and the final 3D image may be reconstructed. In some embodiments, a 10-aperture (e.g., pinhole or slit) spatial filter produces 10 2D image stacks and a signal length of 1 millisecond, corresponding to a throughput of 1,000 cells per second.

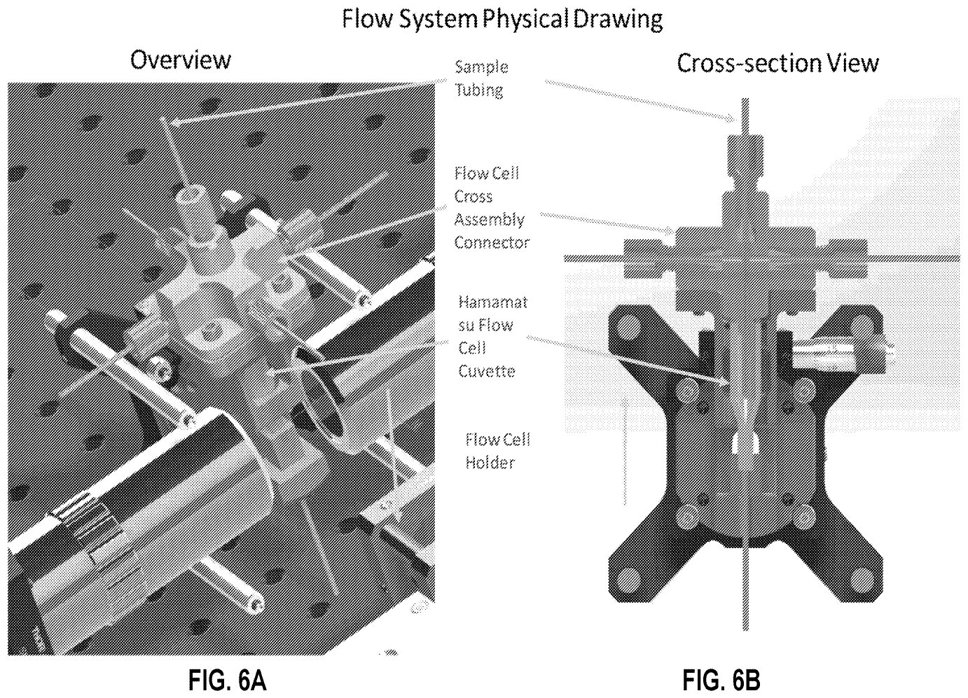

FIGS. 6A-6B depict both overview and cross-section schematics for the flow focusing system including the flow cell and cross assembly connector, in accordance with some embodiments. FIG. 6A depicts an overview schematic of an example flow system (e.g., particle motion device). In some embodiments, the flow system comprises sample tubing, a flow cell cross assembly connector, a flow cell cuvette, and a flow cell holder. FIG. 6B depicts a cross-section view of the flow system, in accordance with some embodiments.

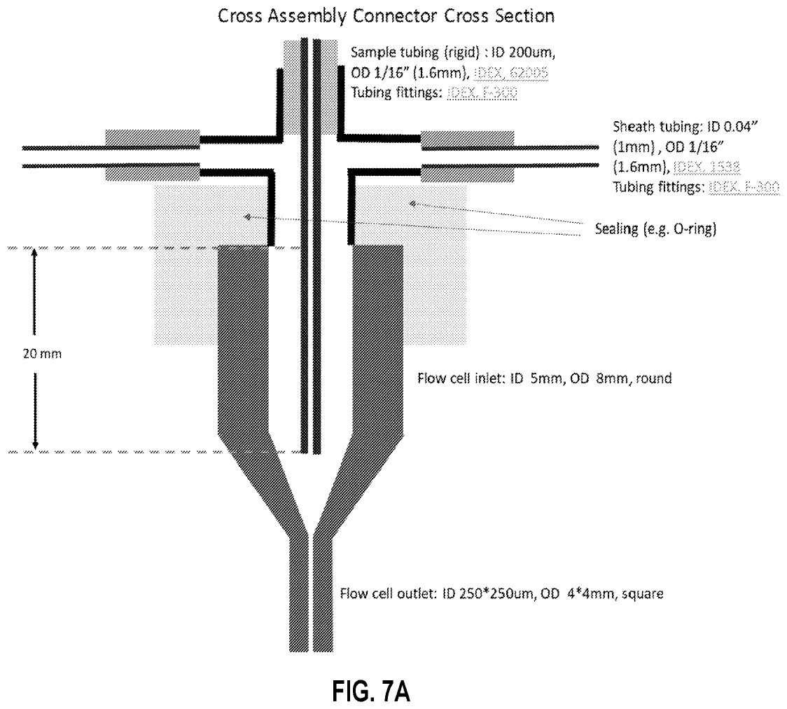

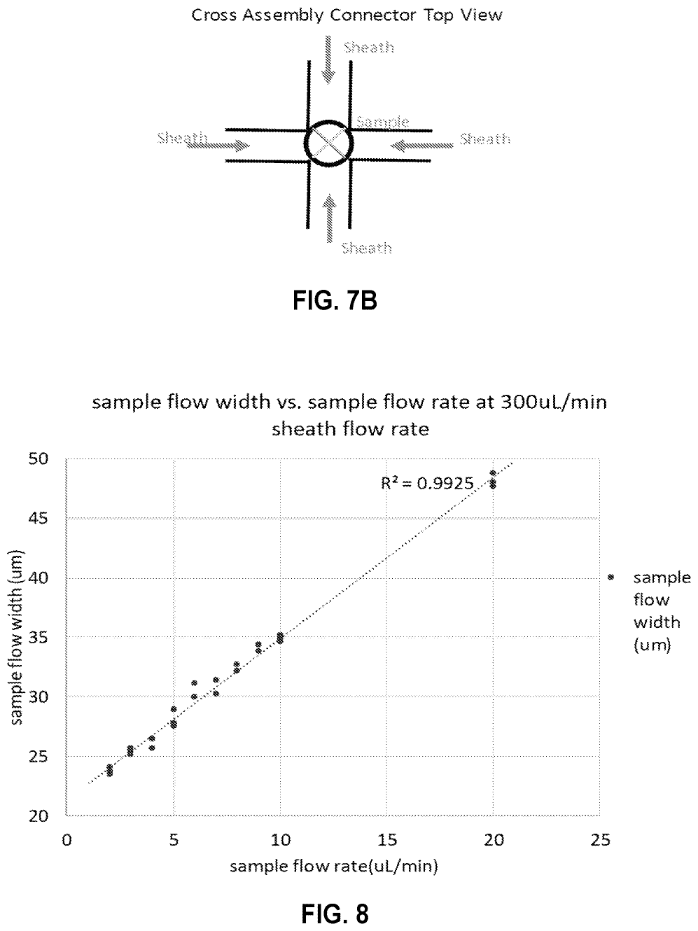

FIGS. 7A-7B depict both cross section and top views of the cross-assembly connector, respectively, in accordance with some embodiments. FIG. 7B depicts a cross-sectional view of the cross-assembly connector according to some embodiments. In some embodiments, the outer diameter of sample tubing (e.g., tubing for carrying the sample to the flow cell) inserted into the cross assembly may be 1.6 millimeters. In some embodiments, the inner diameter of sample tubing inserted into the cross assembly may be 200 microns, as depicted in FIG. 7A. In some embodiments, sheath tubing (e.g., tubing carrying sheath fluid) comprises an outer diameter of 1.6 millimeters and an inner diameter of 1 millimeter. In some embodiments, the flow cell inlet comprises an inner diameter of 5 millimeters and an outer diameter of 8 millimeters. In some embodiments, the flow cell inlet comprises around cross section. In some embodiments, the flow cell outlet comprises inner dimensions of 250 microns by 250 microns and outer dimensions of 4 millimeters by 4 millimeters. In some embodiments, the flow cell outlet comprises a square cross section. FIG. 7B depicts a top-down view of the cross-assembly connector.

FIG. 8 depicts a plot of sample flow width versus sample flow rate, providing for 2D hydrodynamic flow confinement performance, in accordance with some embodiments.

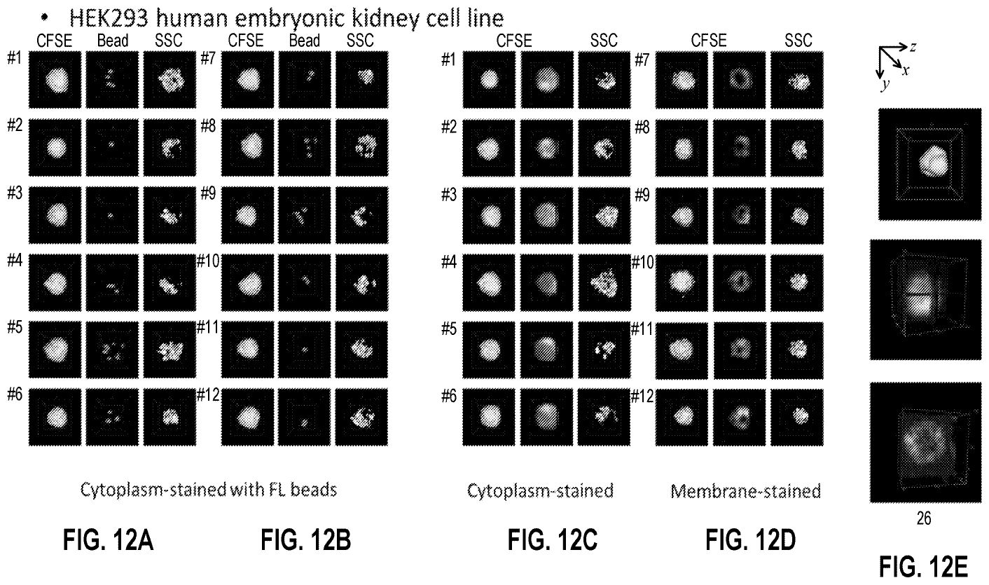

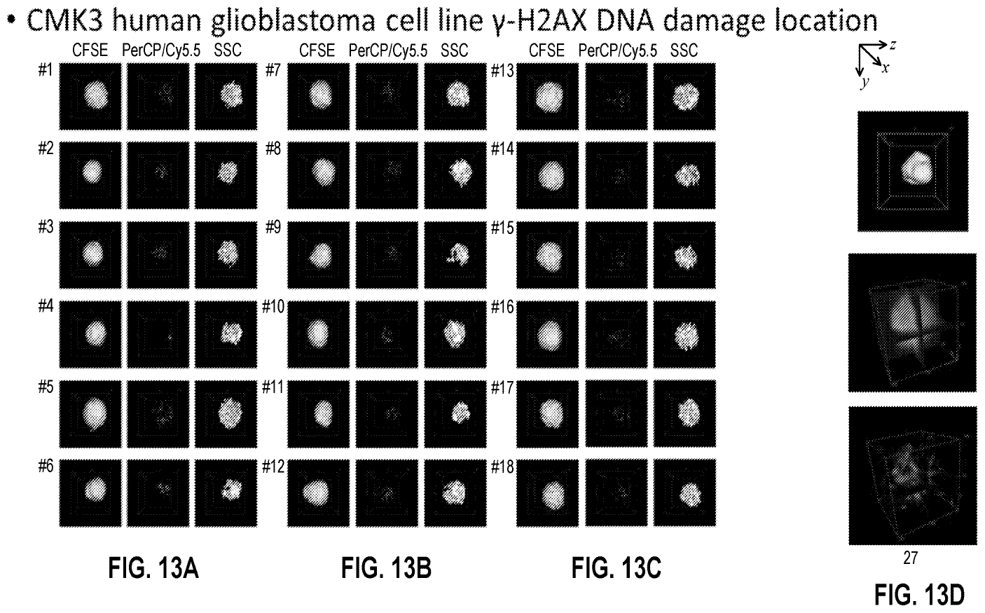

FIGS. 12A-12E show 3D IFC imaging experiment results in accordance with some embodiments. FIGS. 13A-13D show 3D IFC imaging experiment results in accordance with some embodiments.

Extended Focal Depth Stacking by 2D Transmission w/Tilted FSP

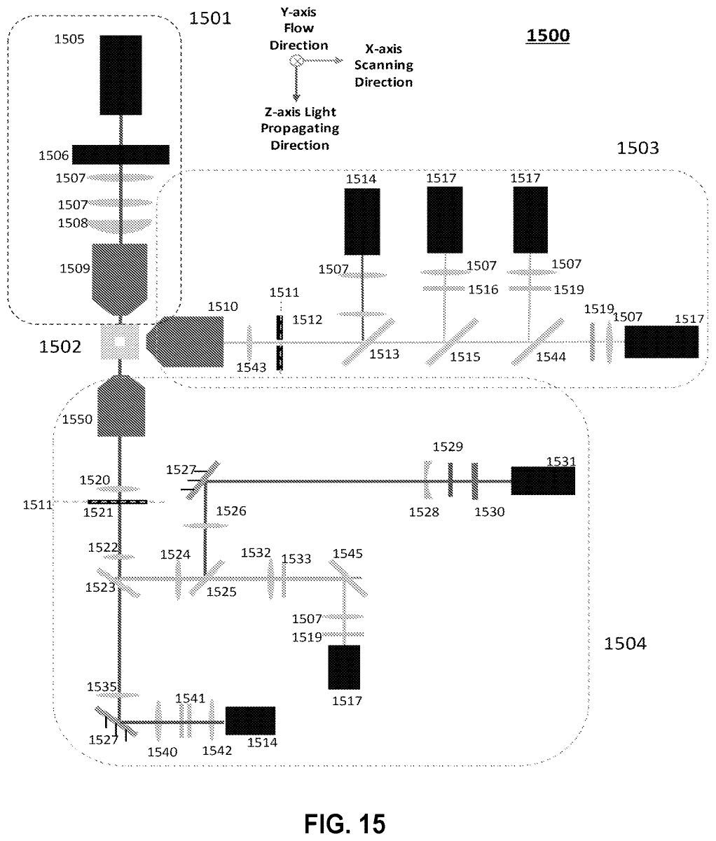

In some embodiments, image stacks comprising extended focal depth, generated by focus stacking images acquired by transmission 2D-IFC allows for generating accurate gating calls more quickly (e.g., less computationally intensive) than image stacks acquired by 3D-IFC. In some embodiments, image stacks comprising extended focal depth are acquired by 2D transmission (e.g., forward detection) detection systems 1504 comprising a forward tilted FSP 1521, as depicted in FIG. 15.

### System

Described herein are various systems for image flow cytometry-based particle sorting comprising a flow cell, a sorting system, an illumination system, a detection system, a data processing system, or a combination thereof. In some embodiments, the system for sorting a particle in a sample comprises: a flow cell configured to allow the particle to move in a flow path in a flow direction; a sorting module fluidly connected to the flow cell; an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; a detection module comprising at least one spatial filter, the at least one spatial filter comprising a forward spatial filter and the at least one spatial filter comprises: a front surface; a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and a data processing module configured to generate a gating signal using the time-dependent signal, and wherein the sorting module is configured to receive the gating signal and sort the particle in response to the gating signal.

In some embodiments, extended focal depth is enabled by 2D transmission imaging further enabled by spatial filters comprising a tilt angle with respect to the laser propagation axis (e.g., Z-axis). In some embodiments, two-dimensional transmission imaging of particles (e.g., cells), allowing for extended focal depth focus stacking, may provide for less computationally intensive processing than 3D IFC data sets, in turn allowing for gating calls in a sufficiently short enough time.

In some embodiments, as shown in FIG. 15, an imaging flow cytometry system 1500 comprises an illumination system 1501, a particle motion system (e.g., flow cell 1502 and fluid pumping components), a side detection system 1503 and a forward detection system 1504.

### Flow Cell

In some embodiments, the particle motion device may be configured to move a sample fluid along a sample flow path (Y-axis), wherein the sample flow path may be surrounded by a sheath flow. In some embodiments, as shown in FIG. 15, the particle motion device comprises a flow cell (FC) 1502. In some embodiments, the flow cell 1502 is configured to allow for a particle (e.g., cell) or sample to travel in the flow direction (Y-axis), wherein the Y-axis is orthogonal to a plane including the AOD scanning direction (X-axis) and the laser propagation direction (e.g., Z-Axis). In some embodiments, the flow cell comprises quartz. In some embodiments, the flow cell comprises a polymer, such as polydimethylsiloxane (PDMS) or cyclic olefin copolymers (COC). In some embodiments, the flow cell exhibits a low autofluorescence.

In some embodiments, the flow cell comprises a cross fitting configured to generate the sheath flow. In some embodiments, the flow cell is configured for 2D hydrodynamic focusing. In some embodiments, the flow cell comprises an inner diameter of about 200 microns. In some embodiments, the flow cell comprises a cone tapered end. In some embodiments, the cone tapered end has an inner diameter of about 250 microns.

### Illumination

In some embodiments, the system comprises an illumination system 1501 as depicted in FIG. 15. In some embodiments, the illumination system 1501 comprises a light source 1505, a light redirection device 1506, a lens 1507, or a combination thereof as depicted and FIG. 15.

In some embodiments, the light source 1505 may be a laser. In some embodiments, the light source 1505 may be a 488 nanometer laser.

In some embodiments, the light redirection device 1506 may be an acoustic optical deflector (AOD).

In some embodiments, the system comprises a focusing lens 1507. In some embodiments, the system comprises a plurality of focusing lenses 1507.

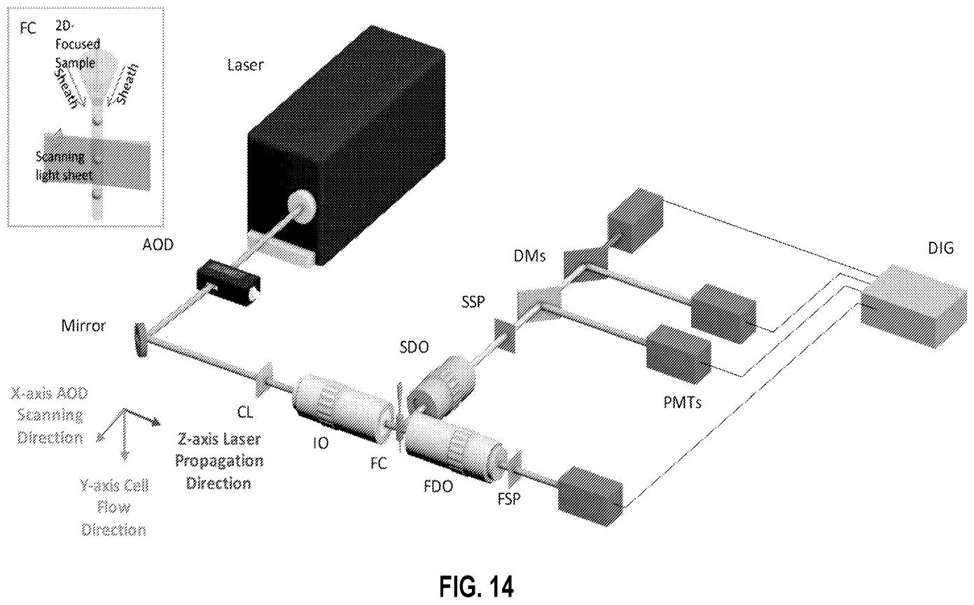

In some embodiments, the system comprises a cylindrical lens 1508. In some embodiments, the cylindrical lens may be configured to create a light sheet as depicted in the upper left corner of FIG. 14.

In some embodiments, the illumination system 1501 comprises an illumination objective. 1509. In some embodiments, the illumination objective 1509 comprises a magnification of 5×, 10×, 20×, or 50×. In some embodiments, the illumination objective 1509 comprises a magnification of 5× or more. In some embodiments, the illumination objective 1509 comprises a magnification of 20× or more.

In some embodiments, the illumination system 1501 comprises a light redirection device 1506. In some embodiments, the light redirection device 1506 may be an acoustic scanning device (AOD).

In some embodiments, the light redirecting device comprises an acoustic optical deflector. In some embodiments, the illumination module further comprises a light source, an excitation filter, a cylindrical lens, or a combination thereof. In some embodiments, the light source, the cylindrical lens and the flow cell are offset along the light propagating direction, wherein the cylindrical lens is positioned between the light source and the flow cell. In some embodiments, the light source comprises a plurality of light sources. In some embodiments, the cylindrical lens and the flow cell are offset along the light propagating direction. In some embodiments, the cylindrical lens is configured to elongate the light beam within the plane comprising the scanning direction and the flow direction, the elongated light beam comprising a light sheet. In some embodiments, the scan comprises a plurality of light sheet positions offset along the light propagating direction. In some embodiments, the at least one light source comprises at least one laser, or at least one broadband light source, or a combination thereof. In some embodiments, the at least one laser comprises a wavelength of about 488 nm. In some embodiments, the broadband light source may comprise a halogen source, a Xenon source, light emitting diode (LED) source, or a combination thereof. In some embodiments, the spatial filter is an optical fiber bundle comprising a plurality of optical fibers. In some embodiments, the aperture comprises a core of an optical fiber of an optical fiber bundle. In some embodiments, the illumination module comprises a digitizer. In some embodiments, the illumination module comprises 12 output channels. In some embodiments, the 12 output channels comprise 11 PMT channels and 1 AOD channel. In some embodiments, data is transmitted with a field programmable gate array (FPGA) into PXIe-BUS.

### Detection

FIG. 14 depicts a system diagram comprising a side detection system 1503 and a forward detection system 1504. In some embodiments, the system as depicted in FIG. 14 may comprise a forward detection objective lens (FDO), a forward spatial filter (FSP), side detection objective lens (SDO), side detection spatial filter (SSP), dichroic mirrors DM, photomultiplier tubes (PMTs), a digitizer (DIG), an acousto-optic deflector (AOD); a cylindrical lens (CL); an illumination objective (IO), a flow cell cuvette (FC), a mirror, a illumination source (e.g. laser), or a combination thereof. In some embodiments, the IO may comprise a magnification power of 20× and a numeric aperture (NA) of 0.42. In some embodiments, FDO may comprise a magnification power of 50× and an NA of 0.55. In some embodiments, SDO may comprise a magnification of 10× and an NA of 0.28.

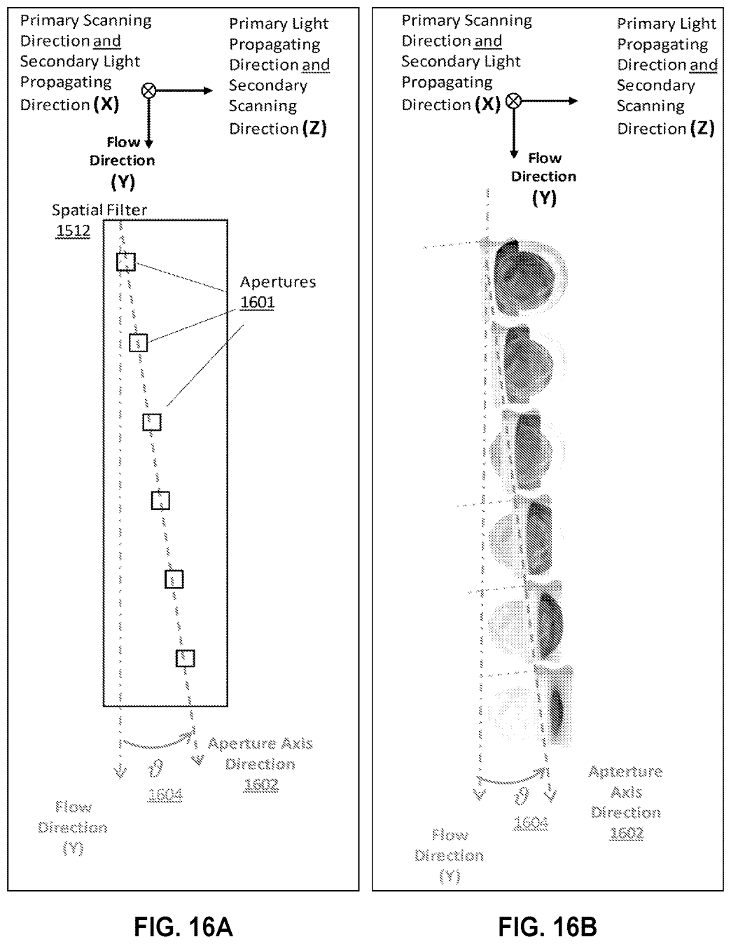

In some embodiments, the system comprises a detection system. In some embodiments, the system comprises a side detection system 1503 as depicted in FIG. 15. In some embodiments, the side detection system 1503 comprises a side detection spatial filter 1512 comprising a plurality of apertures 1601 (e.g., pinholes), the plurality of apertures 1601 arranged in a line 1602 comprising an intersection angle, ϑ 1604, with the direction of flow (Y-axis) depicted in FIG. 16A. In some embodiments, the side detection spatial filter 1512 is offset along the primary scanning direction (e.g., secondary light propagating direction, X, or X-axis), located between the flow cell 1502 and a detector 1517.

In some embodiments, the side detection system 1503 is configured for 3D-IFC. In some embodiments, the side detection system 1503 comprises an image plane 1511 that overlays on the side detection spatial filter 1512 as depicted in FIGS. 15, 16A and 16B.

In some embodiments, the side detection system 1503 is configured to monitor objects (e.g., particles, cells, etc . . . ) flowing within the flow cell 1502. In some embodiments, the side detection monitoring system comprises a camera 1514, at least one focusing lens 1507 and a beam splitter 1513. In some embodiments, the beam splitter 1513 is a beam splitter configured to reflect 10 percent of light and transmit 90 percent of light.

In some embodiments, the side detection system 1503 is configured for side scatter detection. In some embodiments, the side detection system 1503 comprises a side scatter (SSC) detection channel. In some embodiments, the side detection system configured for SSC detection, or the SSC detection channel, comprises a dichromatic mirror (DM) 1515, a 530 nanometer/30 nanometer bandpass filter 1516, a focusing lens 1507 and a detector 1517. In some embodiments, the DM 1515 may be a 506 nanometer long pass (LP) DM 1515. In some embodiments, the detector 1517 may be a photomultiplier tube (PMT) detector 1517.

In some embodiments, the side detection system 1503 may be configured for fluorescence detection. In some embodiments, the side detection system 1503 may be configured for epifluorescence detection. In some embodiments, the side detection system comprises a fluorescence (FL) detection channel. In some embodiments, the side detection system comprises a dichromatic mirror 1544, a band pass filter 1519, a focusing lens 1507 and a detector 1517 as depicted in FIG. 15. In some embodiments, the dichroic mirror 1544 comprises a 620 long-pass (LP) dichroic mirror as depicted in FIG. 15. In some embodiments, the detector 1517 may be a PMT. In some embodiments, the side detection system 1503 may comprise at least one fluorescence detection channel. In some embodiments, the side detection system may comprise two fluorescence detection channels as depicted in FIG. 15. In some embodiments, the side detection system may comprise three or more fluorescence channels.

In some embodiments, the system 1500 comprises a forward detection system 1504. In some embodiments, the forward detection system 1504 may be configured for transmission detection. In some embodiments, the forward detection system 1504 may be configured for focus stacking of 2D transmission images. In some embodiments, the forward detection system 1504 may be configured for transmission fluorescence detection. In some embodiments, the forward detection system 1504 may comprise a forward camera monitoring system.

In some embodiments, the forward detection system 1504 comprises a detection objective 1510, a tube lens 1520, a spatial filter 1521, a lens 1522, a beam splitter 1523 and a lens 1524. In some embodiments, the detection objective 1510 is configured for a magnification of 10×. In some embodiments, the detection objective may comprise a magnification of 5×, 10×, 20×, 30×, 40× or 50×. In some embodiments, the tube lens 1543 may comprise a focal length of 40 millimeters (e.g, f=40 millimeters). In some embodiments, the forward detection system comprises a spatial filter 1521.

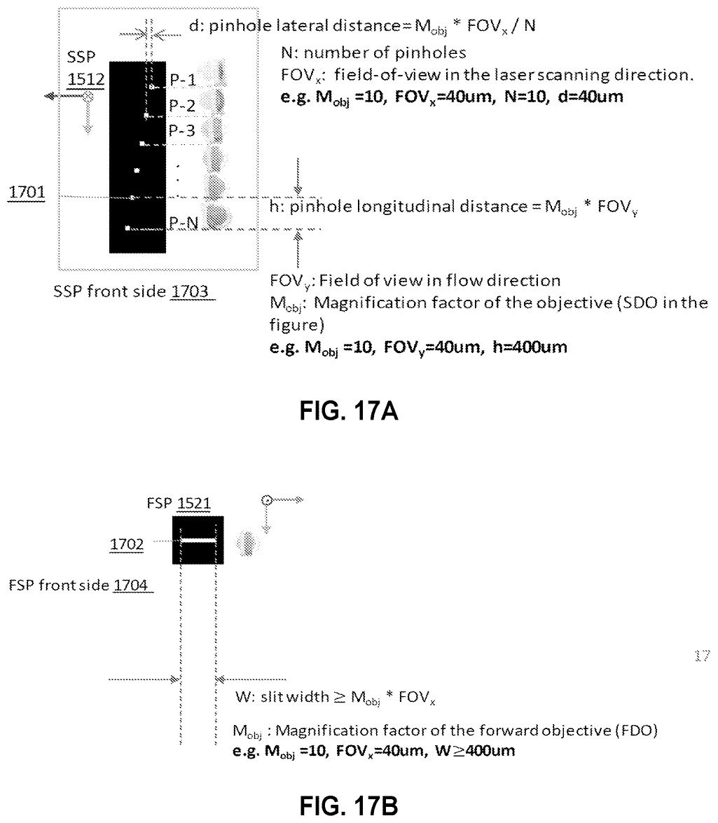

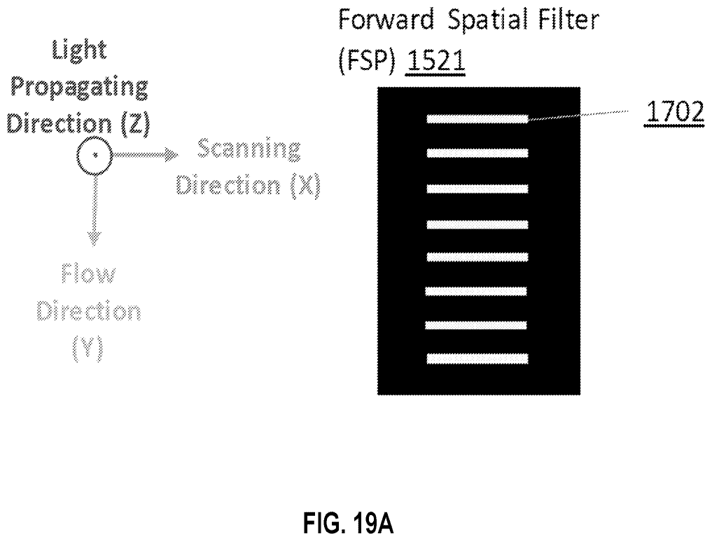

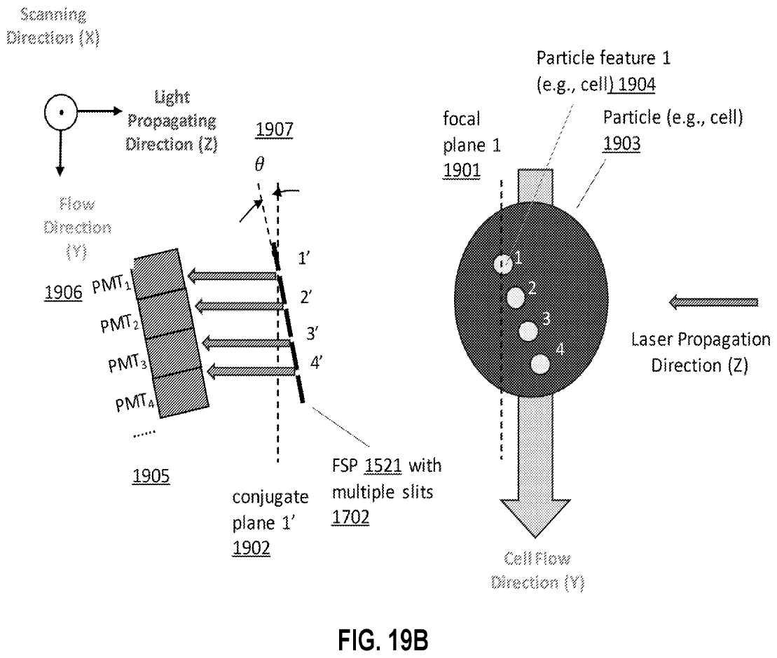

In some embodiments, the spatial filter 1521 is a forward spatial filter (FSP) 1521 as depicted in FIGS. 15, 17B, 19A and 19B. As depicted in FIGS. 17B and 19A the FSP 1521 may comprise at least one aperture (e.g., slit) 1702. In some embodiments, the slit 1702 may comprise a slit width, W, as depicted in FIG. 17B. In some embodiments, the slit width, W, is greater than or equal the magnification factor of the forward objective (M_{obj}) multiplied by the field of view along the X-axis (FOVₓ), which is represented by the following equation:

$$W : slit width \geq {M}_{obj} * {FOV}_{x}$$

In some embodiments, the magnification factor M_{obj}=10 and the field-of-view along the laser scanning direction FOVₓ=40 microns, wherein the slit width of for the forward spatial filter (FSP) W>=400 microns.

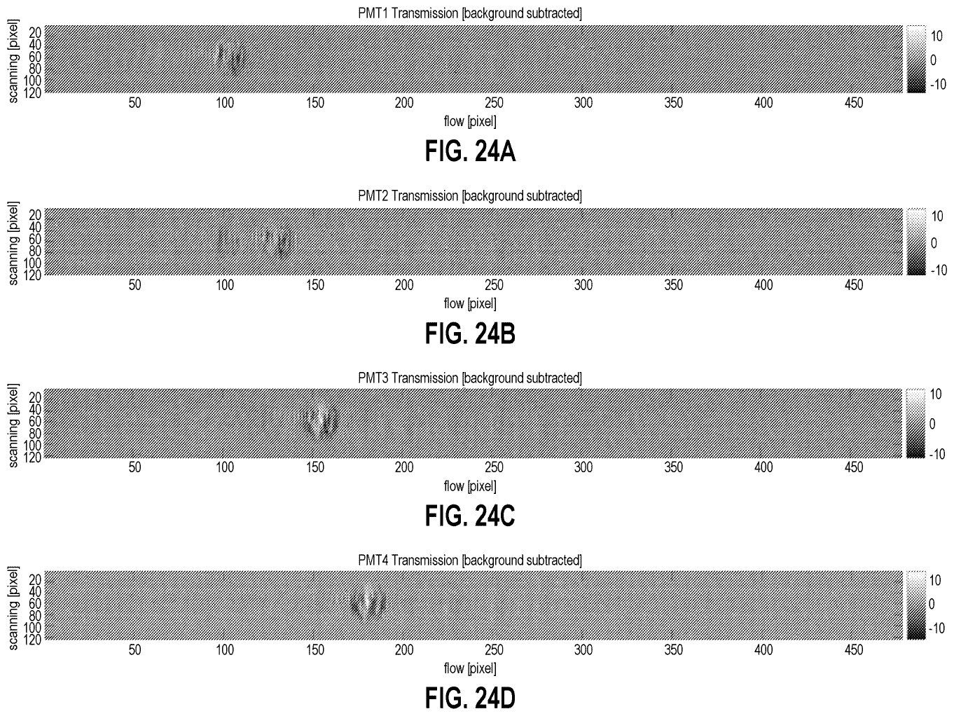

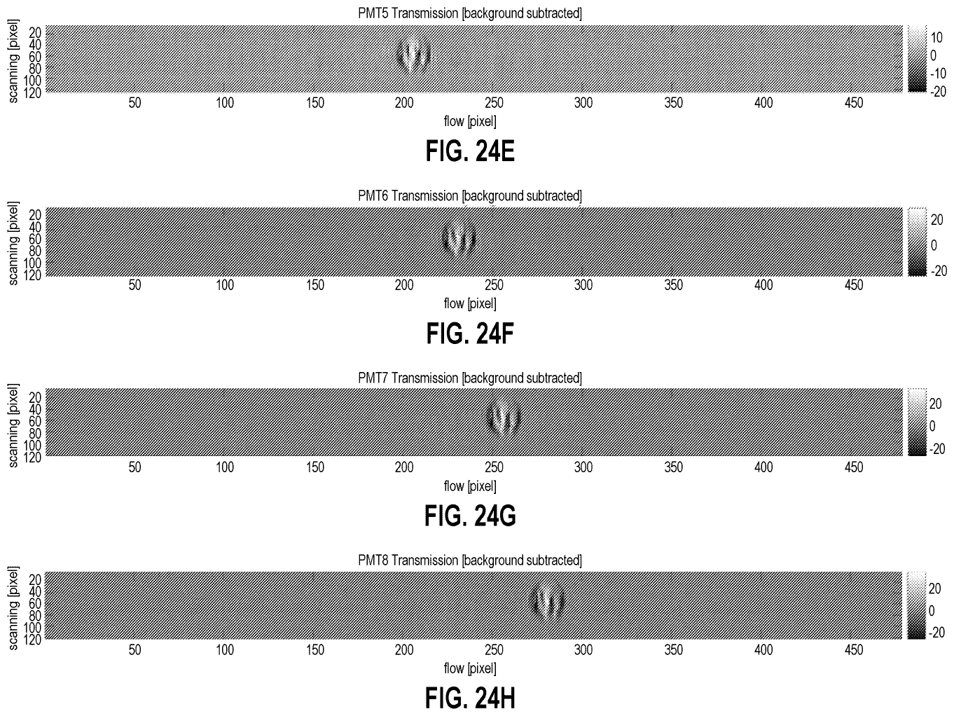

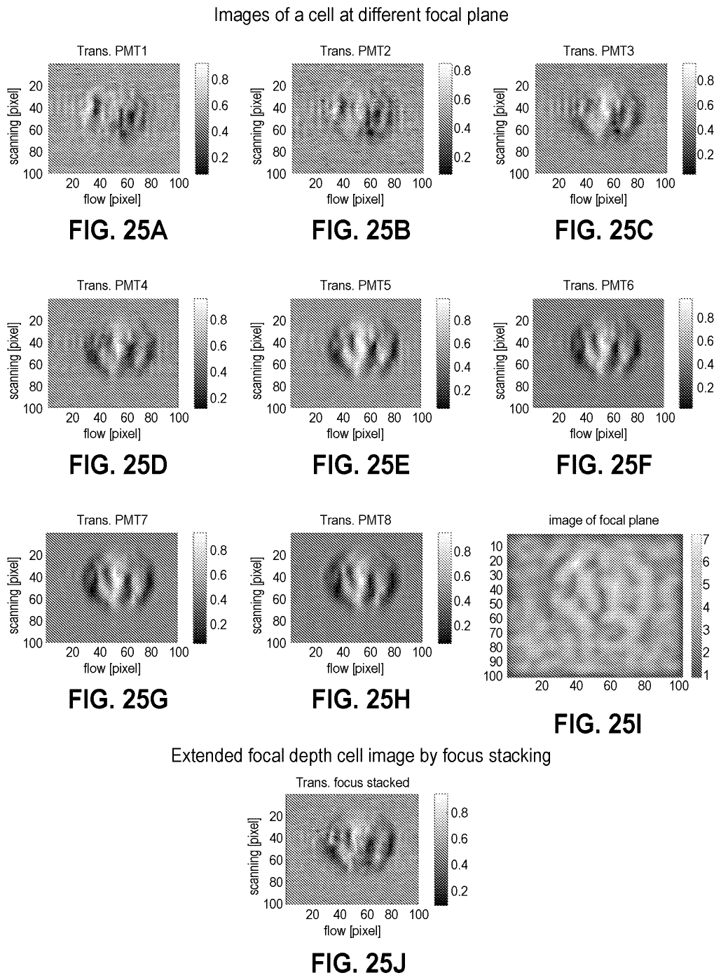

In some embodiments, the forward detection system 1504 may be configured to acquire images at different focal lengths. In some embodiments, the forward detection system 1504 may be configured to acquire transmission images of objects (e.g., particles or cells) flowing through the flow cell 1502, wherein the images are acquired at different focal lengths as depicted in the images of FIGS. 24-25. In some embodiments, as depicted in FIG. 19B, the FSP 1521 comprises a forward tilt angle, θ, 1907 thus allowing for at least one aperture 1702 (e.g., slit) of the spatial filter 1521 to comprise a different position on the laser propagating direction (e.g., Z-axis or laser propagation axis). As depicted in FIG. 19B, each PMT 1906 of a PMT array 1905 detects only the light passing a single slit 1702, in accordance with some embodiments. In such embodiments, a focal plane 1901 may coincide with a particle element 1904 of a particle 1903 traveling along the laser propagation direction (Z-axis) within the flow cell 1502, wherein the focal plane 1901 corresponds to a conjugate focal plane 1902 that exists at the single slit 1702 of the FSP 1521 as depicted in FIG. 19B. In such embodiments, where the FSP 1521 comprises a tilt angle, θ, 1907, as depicted in FIG. 19B, a particle traveling along the flow direction (Y-axis) may then be scanned along the laser propagation direction (Z-axis). In some embodiments, as depicted in FIG. 19B, images may be acquired at different focal planes 1901 along the laser propagation direction (Z-axis) of the particle 1901 as depicted as the particle 1903 travels along the flow direction (Y-axis). In some embodiments, the forward detection system 1504 may comprise a lens 1522 as depicted in FIG. 15. In some embodiments, the forward detection system 1504 may comprise a lens 1522 as depicted in FIG. 15, wherein the lens 1522 comprises a focal length of 19 millimeters (e.g., f=19 millimeters). The lens 1522 is used to collimate the light detected from forward detection objective (FDO) 1550. In some embodiments, the forward detection system may comprise a lens 1524 as depicted in FIG. 15. The lens 1524 and the lens 1522 form an optical relay system to expand the image magnification ratio. In some embodiments, the forward detection system 1504 may comprise a beam splitter 1523. The beam splitter 1523 is used to split the light path for the forward monitoring camera and forward detection PMT elements. In some embodiments, the beam splitter 1523 is configured to allow for 90 percent of light to be reflected and 10 percent of light to be transmitted (e.g., 90:10 R:T beam splitter). In some embodiments, the forward detection system 1504 comprises a lens 1526 to collimate the light, a dielectric mirror 1527 to redirect the laser beam or a combination thereof. In some embodiments, the forward detection system 1504 comprises a cylindrical lens 1528 to converge the light on AOD scanning direction, a band pass filter 1529, a neutral density filter 1530 to attenuate the laser light, and a PMT array detector 1531. In some embodiments, the lens 1526 comprises a focal length of 500 millimeters (e.g., f=500 millimeters). In some embodiments, the dielectric mirror 1527 allows for changing the beam direction to reduce the system footprint. In some embodiments, the cylindrical lens 1528 allows for focusing of the scanning laser light sheet onto the detector 1531. In some embodiments, the band pass filter 1529 may be a 488 nanometer band pass filter with a 10 nanometer transmission spectral window. In some embodiments, the neutral density filter (ND) 1530 is a 30D neutral density filter. In some embodiments, the detector 1531 is an 8×1 PMT array (e.g., the detector comprises 8 PMT elements in a single row). In some embodiments, the forward detection system 1504 may be configured for transmission fluorescence detection. In some embodiments, where the forward detection system 1504 is configured for transmission fluorescence imaging, the forward detection system 1504 comprises a forward detection objective (FDO) 1550, a lens 1520, a forward spatial filter 1521, a lens 1522, a beam splitter 1523, a lens 1524, a dichromatic mirror 1525, a lens 1532, a filter 1533, a dichromatic mirror 1515, a lens 1507, a filter 1519 a detector 1517, or a combination thereof. In some embodiments, wherein the forward detection system 1504 is configured for transmission fluorescence imaging, the forward detection system comprises, in the following order along the laser propagation direction (Z-axis): a forward detection objective (FDO) 1550, a lens 1520, a forward spatial filter 1521, a lens 1522, a beam splitter 1523, a lens 1524, a dichromatic mirror 1525, a lens 1532, a filter 1533, a dichromatic mirror 1515, a lens 1507 and a filter 1519 and a detector 1517 as depicted in FIG. 15. In some embodiments, the forward detection system comprises two or more separate fluorescent channels, each configured for transmission fluorescence detection. In some embodiments, as depicted in FIG. 15, the forward detection objective (FDO) 1550 may comprise a magnification of 10×, 20×, 30×, 40× or 50×. In some embodiments, as depicted in FIG. 15, the lens 1520 may be a tube lens comprising a focal length of 40 millimeters (e.g., f=40 millimeters). In some embodiments, a 50× magnification detection objective lens is combined with a 40 millimeters tube lens, where the combination allows for an effective magnification of 10 via. In some embodiments, the tube lens is configured to allow for an adjustment of the effective magnification ratio when the tube lens is combined with a detection objective. In some embodiments, as depicted in FIG. 15, the lens 1522 may comprise a focal length of 19 millimeters (e.g., f=19 millimeters). In some embodiments, the beam splitter 1523 is configured to allow for 90 percent of light to be reflected and 10 percent of light to be transmitted (e.g., 90:10 R:T beam splitter). In some embodiments, the lens 1524 may comprise a focal length of 275 millimeters (e.g., f=275 millimeters). The lens 1524 and the lens 1522 form an optical relay system to expand the image magnification ratio. In some embodiments, the DM 1525 may be a 506 nanometer long pass (LP) DM. In some embodiments, the lens 1532 may comprise a focal length of 125 millimeters (e.g., f=125 millimeters). The lens 1524 and the lens 1532 form an optical relay system to reduce the image magnification ratio. In some embodiments, the filter 1533 may be a 500 nm LP filter. In some embodiments, the DM 1545 may be a 562 LP DM. In some embodiments, the lens 1507 may be a focusing lens. The lens 1507 is used to focus the light to the active area in detector 1517. In some embodiments, the filter 1519 may be a band pass filter. In some embodiments, the detector 1517 may be PMT detector.

In some embodiments, the forward detection system 1504 may comprise a forward camera monitoring system as depicted in FIG. 15. In some embodiments, wherein the forward detection system 1504 is configured for monitoring the particles traveling through the flow cell with a camera, the forward detection system comprises a forward detection objective (FDO) 1550, a lens 1520, a forward spatial filter 1521, a lens 1522, a beam splitter 1523, a lens 1535, a dielectric mirror 1527, a lens 1540, a filter 1541, a lens 1542, a detector 1514, or a combination thereof. In some embodiments, the lens 1535 may comprise a focal length of 50 millimeters (e.g., f=50 millimeters). In some embodiments, the lens 1540 may comprise a focal length of 60 millimeters (e.g., f=60 millimeters). In some embodiments, the filter 1541 may be a 500 nanometer LP filter. In some embodiments, the lens 1542 may comprise a 30 millimeters focal length (e.g., f=30 millimeters). In some embodiments, the detector 1514 may be a camera.

In certain aspects, as depicted in FIG. 17A, a side detection spatial filter (SSP) 1512 comprising 6 apertures 1701 (e.g., pinholes), wherein the apertures are offset in the AOD scanning direction (e.g., X-axis or X-direction). In some embodiments, the SSP 1512 comprises an orientation within the system 1500 in relation to the coordinates as shown in FIG. 17A. In accordance with some embodiments, as depicted in FIG. 17A, a side depicts the pinhole lateral distance (d), which is a function of the magnification of the objective (M_{obj}) times the field of view (FOV) divided by the number of pinholes (N) as represented by the equation:

$$d : pinhole lateral distance = {M}_{obj} * {FOV}_{x} / N$$

FOVₓ: field-of-view in the laser scanning direction (Z-axis).

In some embodiments, M_{obj}=10, FOVₓ=40 microns, N=10, d=40 microns.

$$h : pinhole longitude distance = {M}_{obj} * FO {V}_{y}$$

In accordance with some embodiments, FIG. 17A also depicts the pinhole longitudinal distance (h) which is a product magnification factor (M_{obj}) of the side detection objective lens (SDO) and the field of view in the flow direction (Y-axis)(FOVy) as represented by the following equation:

$$h : pinhole longitude distance = {M}_{obj} * FO {V}_{y}$$

In some embodiments, M_{obj}=10, FOV_{y}=40 microns, h=400 microns.

FIG. 17B depicts a forward spatial filter FSP 1521 comprising one aperture (e.g., slit) 1702, in accordance with some embodiments. In some embodiments, the FSP 1521 comprises an orientation within the system 1500 in relation to the coordinates as shown in FIG. 17B. As depicted in FIG. 17B, in some embodiments, the slit width (W), wherein the slit width (W) must be greater than or equal to the product of the magnification factor (M_{obj}) of the forward objective (FDO) and the field of view in the laser scanning direction (Z-axis) (FOVₓ). as represented in the following equation:

$$W : slit width \geq {M}_{obj} * {FOV}_{x}$$

In some embodiments, the M_{obj}=10, FOVₓ=40 microns, W>400 microns.

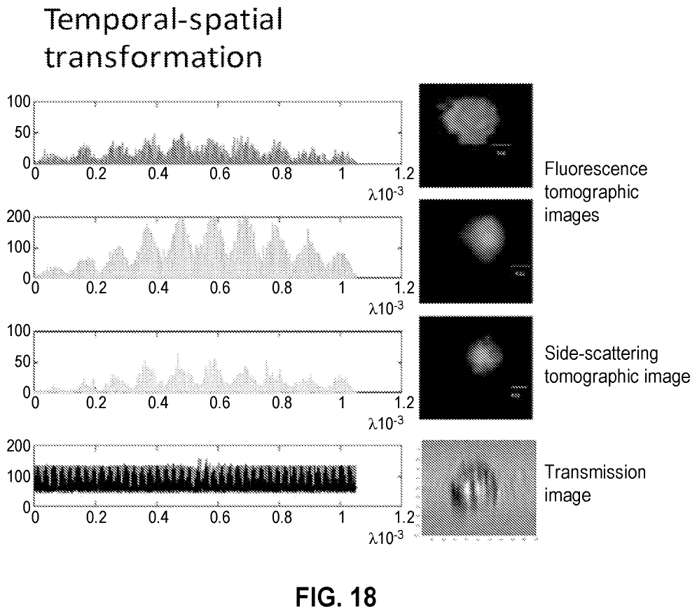

FIG. 18 depicts temporal-spatial transformation two fluorescence channels, a side scatter channel and a transmission channel in accordance with some embodiments. FIG. 18 also depicts corresponding images of the particle, shown to the right of each respective temp oral-spatial transforms in accordance with some embodiments.

FIG. 19A shows a forward spatial filter (FSP) 1521 as viewed head-on from the laser propagation axis, in accordance with some embodiments. A coordinate diagram is shown to the left, denoting the orientation of the FSP 1521 within the system 1500 in accordance with some embodiments.

FIG. 19B shows a schematic of the FSP 1521 and PMT array 1905 configured for acquisition of multiple 2D transmission images at different focal planes, in accordance with some embodiments. In some embodiments, the forward detection PMT array 1905 may be aligned with projected light transmitted through the slits 1702 of the FSP 1521. In some embodiments, each PMT element (e.g., each individual PMT of the PMT array) 1906 detects only the light passing a single slit 1702. In some embodiments, the FSP 1521 may be oriented at an angle θ 1907 from the axis of flow (e.g., Y-axis). In this case, the laser beam transmits through the particle (e.g., cell) 1903 and through each slit 1702 of the FSP 1521 creating a transmitted beam corresponding to each slit 1702. In some embodiments, each PMT 1906 of the PMT array 1905 may be positioned to collect only the light from the corresponding slit 1702. In such embodiments, this may result in each PMT 1906 of the PMT array 1905 imaging only the light being transmitted through the corresponding focal plane 1901 of the particle 1903, as the particle travels along the flow direction (Y-axis). In some embodiments, as depicted in FIG. 19B, 1, 2, 3, and 4 are focal points on the cell and 1′, 2′, 3′, 4′ the conjugate points. For example, as shown in FIG. 19B, the system is configured such that PMT1 1906 acquires image 1 of a particle feature 1904 at position 1 of the particle 1903 at a certain time point. In some embodiments, PMT2 acquires image 2 of the particle 1903 at focal point 2 at the same time point. In some embodiments, PMT3 acquires image 3 of the particle 1903 at focal point 3 at the same time point. In some embodiments, PMT4 acquires image 4 of the particle 1903 at focal point 4 at the same time. Only focal plane 1 1901 and conjugate plane 1 1902 are shown for simplicity. In some examples, images 1-4 may be stacked (e.g., assembled into a matrix), each acquired at different focal planes 1901, thus creating a composite 2D image with extended focal depth. In some embodiments, this method is referred to a focus stacking.

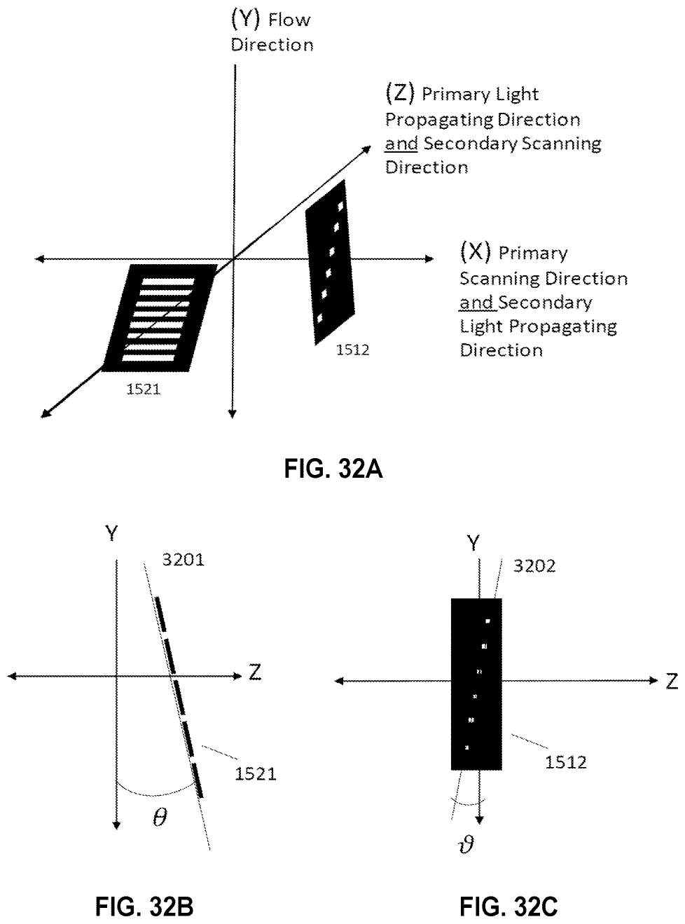

FIGS. 32A-32C provide schematic views of the forward (e.g., transmission) spatial filter 1521 and the side detection spatial filter 1512 as well as the positioning of the filters relative to the system axes. In some embodiments, the systems axes include a flow direction (e.g. flow direction axis, Y, or Y-axis), a primary light propagating direction (e.g., light propagating direction axis, Z, or Z-axis), and a primary scanning direction (e.g., primary scanning direction axis, X, or X-axis). In some embodiments, the primary light propagation direction is coincident (e.g., parallel) with a secondary scanning direction as depicted in FIG. 32A. In some embodiments, the primary scanning direction is coincident (e.g., parallel) with a secondary light propagating direction as depicted FIG. 32A. In some embodiments, the secondary light propagating direction may comprise light emitted by the particle in the flow path. In some embodiments, the secondary light propagating direction may comprise light reflected by (e.g., off of) the particle in the flow path. In some embodiments, the secondary light propagating direction may comprise light scattered by the particle in the flow path. In some embodiments, the secondary light propagating direction may comprise light having interacted with the particle in the flow path. In some embodiments, the secondary light propagating direction is perpendicular to the primary light propagating direction. In some embodiments, the spatial filter comprises a front surface and a plurality of apertures. In some embodiments, the plurality of apertures may be arranged in a line comprising a tilting angle with the flow direction. In some embodiments, the plurality of apertures of the forward (e.g., transmission) spatial filter 1521 may be arranged in a line 3201 comprising a tilting angle, θ, with the flow direction as depicted in FIG. 32B. In some embodiments, the plurality of apertures of the side detection spatial filter 1512 may be arranged in a line 3202 comprising a tilting angle, ϑ, with the flow direction (e.g., Y or Y-axis) as depicted in FIG. 32C.

In some embodiments, a plurality of focal planes corresponds to the plurality of apertures. In some embodiments, at least a subset of the plurality of focal planes reside within the flow path. In some embodiments, the forward spatial filter is configured for transmission detection. In some embodiments, each of the plurality of focal planes are orthogonal to the light propagating direction. In some embodiments, each of the focal planes are offset to each other along the light propagating direction. In some embodiments, the tilting angle of the forward spatial filter, θ, is about 20 degrees to about 60 degrees. In some embodiments, the at least one spatial filter comprises a side detection spatial filter. In some embodiments, each of the plurality of focal planes are orthogonal to a secondary light propagating direction and offset to each other along the secondary light propagating direction. In some embodiments, the light propagating direction and the secondary light propagating direction are perpendicular to each other. In some embodiments, the tilting angle of the side spatial filter, ϑ, is about 2 degrees to about 15 degrees. In some embodiments, a particle motion device comprising a flow cell, the particle motion device configured to move a sample fluid along the flow path in the flow direction, the flow path surrounded by a sheath flow. In some embodiments, the particle comprises a plurality of particles. In some embodiments, the particle feature comprises a plurality of particle features. In some embodiments, the particle feature comprises a region on or within the particle. In some embodiments, the region on or within the particle comprises a plurality of regions on or within the particle. In some embodiments, a first particle feature of the plurality of particle features comprises a first region of the plurality of regions on or within the particle. In some embodiments, a second particle feature of the plurality of particle features comprises a second region of the plurality of regions on or within the particle.

In some embodiments, the system is configured to detect 2D cell images by darkfield microscopy. In some embodiments, the particle is detected by darkfield microscopy. In some embodiments, light being diffracted by the particle in a diffracted direction at a diffracted angle from the propagating direction transmits through an aperture of a spatial filter, the aperture arranged in a position of the diffracted direction. In some embodiments, light is diffracted by the particle in a diffracted direction. In some embodiments, the diffracted direction is at a diffracted angle from the propagation direction. In some embodiments, the light being diffracted by the particle transmits through an aperture of a darkfield spatial filter. In some embodiments, the darkfield spatial filter comprises a central obscuration disk.

In some embodiments, a time-dependent signal comprises a plurality of time-dependent signal features. In some embodiments, the time-dependent signal comprises a first time-dependent signal feature of the plurality. In some embodiments, the time-dependent signal comprises a second time-dependent signal feature of the plurality. In some embodiments, the first time-dependent signal feature correlates to the first particle feature, the second particle feature or a combination thereof. In some embodiments, the second time-dependent signal feature correlates to the first particle feature, the second particle feature or a combination thereof. In some embodiments, the particle comprises a cell. In some embodiments, the particle feature comprises an organelle, a partial organelle, or a plurality of organelles of the cell. In some embodiments, the cell is a gamma radiation damaged cell with histone related staining. In some embodiments, the time-dependent signal comprises a plurality of time-dependent signals. In some embodiments, the time-dependent signal comprises at least one aperture-line-scan-time-dependent signal. In some embodiments, the aperture-line-scan-time-dependent signal comprises a light-intensity-time point. In some embodiments, the at least one aperture-line-scan-time-dependent signal is acquired via a single aperture. In some embodiments, the aperture-line-scan-time-dependent signal comprises a 1-dimensional (1D) profile of the particle. In some embodiments, the time-dependent signal comprises a 2D profile of the particle. In some embodiments, the time-dependent signal comprises a 3D profile of the particle.

In some embodiments, the detector comprises a plurality of detectors. In some embodiments, the detector comprises a PMT, an APD, or a CCD detector. In some embodiments, the time-dependent signal comprises data correlating to the different features of the particle in relation to 3D space. In some embodiments, the data processing module is configured to generate 2D image slices of the particle, the 2D image comprising the different features of the particle. In some embodiments, the data processing module is configured to generate a 3D image of the particle, the 3D image comprising the different features of the particle.

In some embodiments, the system further comprises a dielectric mirror configured to elongate the laser beam. In some embodiments, the detection module comprises a focal depth of about 5 microns to about 70 microns. In some embodiments, the detection module comprises a focal depth of about 100 microns. In some embodiments, at least the illumination module, the detection module, the data processing module, or a combination thereof is configured for forward (e.g., transmission) detection.

In some embodiments, at least the illumination module, the detection module, the data processing module, or a combination thereof is configured for side detection. In some embodiments, at least the illumination module, the detection module, the data processing module, or a combination thereof is configured for fluorescence detection. In some embodiments, the flow cell comprises an outer surface, wherein the outer surface comprises at least one region that is orthogonal to light scattered by the particle. In some embodiments, the side scatter detector is configured to detect the light scattered by the particle at a side scatter detection angle from about 70 degrees to about 110 degrees.

In some embodiments, the detection module is configured for imaging flow cytometry. In some embodiments, the detection module is configured for three-dimensional imaging flow cytometry. In some embodiments, the detection module is configured for two-dimensional transmission imaging flow cytometry. In some embodiments, the system further comprises at least two output channels, each output channel fluidly connected to the sorting module, wherein the sorting module is configured to receive the gating signal and sort the particle, into one of the at least two output channels. In some embodiments, the illumination module comprising a light redirection device is configured to scan a light beam in a scanning direction, wherein the scanning direction is within about ±10 degrees to a perpendicular orientation with the flow direction, and wherein the light beam is propagated in a light propagating direction within about ±10 degrees to an orthogonal orientation to a plane comprising the flow direction and the scanning direction.

### Data Processing Components

Described herein are various embodiments of system components configured for data processing. In some embodiments, data processing components are configured for generating a gating signal via a trained machine learning algorithm using the time-dependent signal.

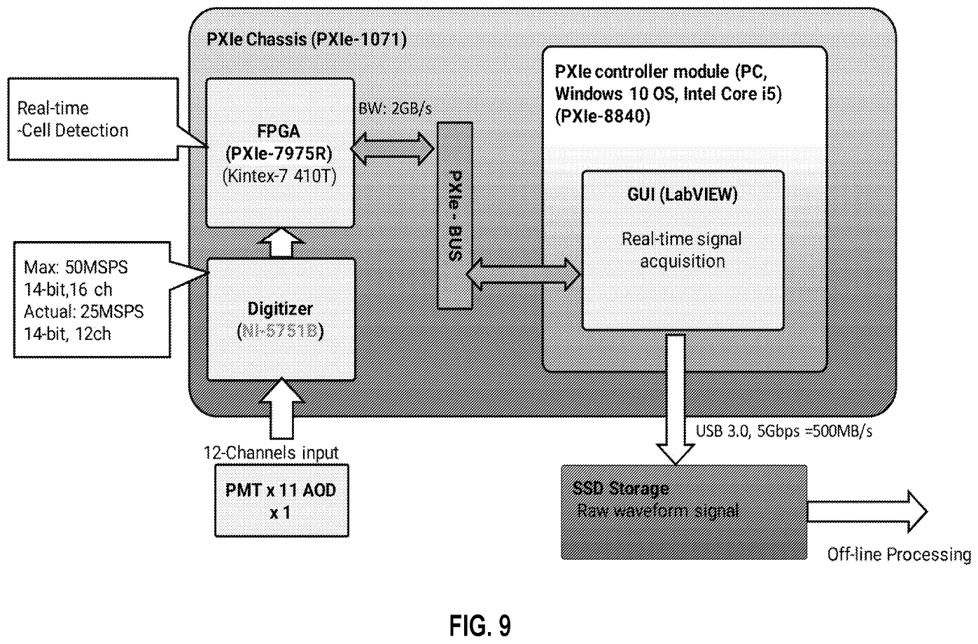

FIG. 9 depicts a schematic representation of data processing components in accordance with some embodiments. As depicted in FIG. 9, in some embodiments, data processing components may comprise a field programmable gate array (FPGA), a digitizer, a PXIe-BUS, a PXIe controller module and SSD storage. In some embodiments, the FPGA, a digitizer, a PXIe-BUS, a PXIe controller module are included within a PXIe Chassis.

In some embodiments, the data processing module comprises a data processing pipeline, the pipeline configured to: obtain time-dependent data; parse time-dependent data; generate intensity statistics; and determine a gating.

### Sorting Components

Described herein are various systems and devices for sorting particles (e.g., cells). In some embodiments, sorting systems and/or devices may be configured to receive a gating signal and sort a portion of the sample fluid comprising the particle, into one of the at least two output channels in response to the gating signal.

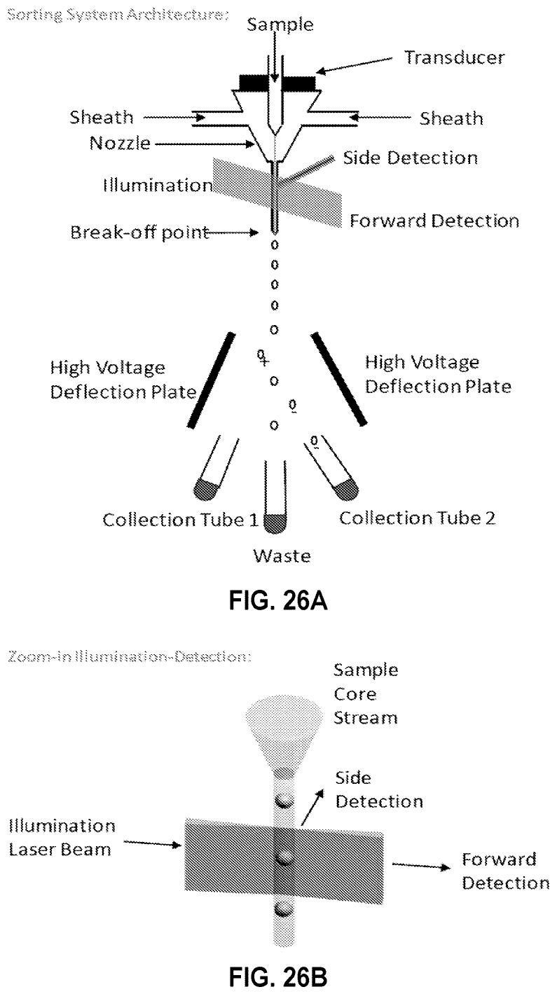

Described herein are various systems and devices for sorting. In embodiments, various systems for sorting may comprise a jet-in-air sorting system as depicted in FIG. 26A. In some embodiments, the system comprises a nozzle, high voltage deflection plates, collection tubes, or a combination thereof. In certain aspects, the sample to be analyzed may be introduced into the nozzle and then 2D hydro-dynamically focused by the sheath flow. In some embodiments, the system may be configured to allow the fluid stream to emerge from the nozzle outlet. In some embodiments, the samples may be illuminated by a scanning light sheet. In some embodiments, the samples may be illuminated by a scanning light sheet, wherein the samples pass through a laser interrogation area. FIG. 26B shows a detailed illumination and detection diagram, in accordance with some embodiments. In some embodiments, the sample density may be controlled such that only one particle (e.g, cell) is present in the laser illumination area at a given time. In some embodiments, where a single particle (e.g., cell) passes through the laser interrogation area, the three-dimensional (3D) side-scattering and fluorescent signals and the two-dimensional (2D) transmission signal may be collected simultaneously. Downstream to the laser interrogation area, in accordance with some embodiments, the system may be configured to split the sample stream into individual droplets containing single particles (e.g., cells), via the high-speed vibration of the nozzle. In some examples, the system may be configured to allow for collected signals to be analyzed and the sorting decision to be generated before the droplet generation. In some embodiments, the system may be configured for droplets to contain positive charges, no charge, and negative charges, thus allowing for the droplets to be separated into 3 different collection tubes. In some embodiments, the system may comprise greater than 3 collection tubes. In some embodiments, the system may comprise greater than 3 collection tubes, based on the charge amount that may be applied to the droplets.

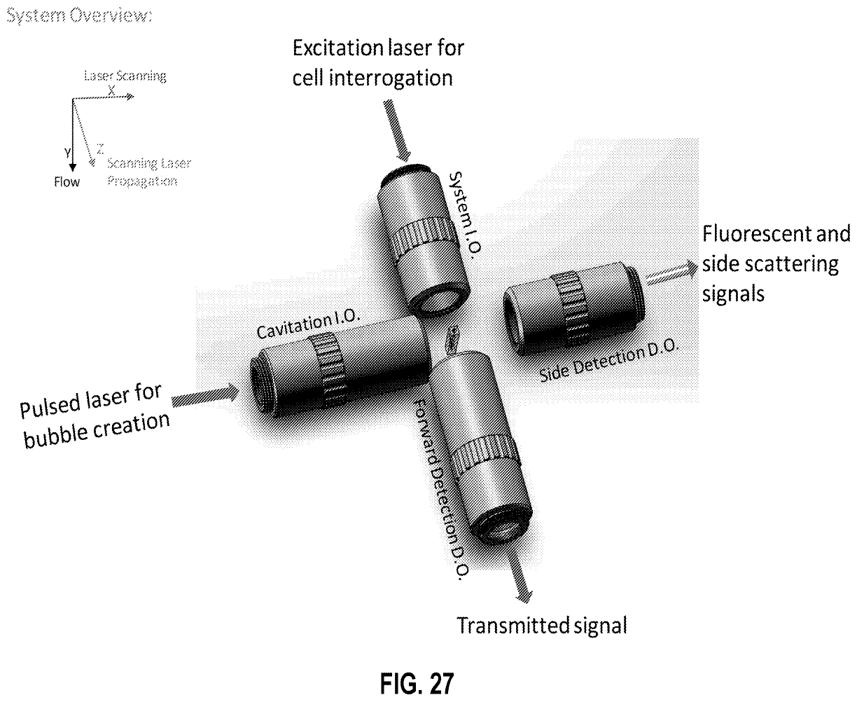

Described herein are various systems and devices configured for laser cavitation sorting. In some embodiments, the system may comprise the system as depicted in FIG. 27. In some embodiments, the system may comprise a cuvette to couple a laser cavitation bubble sorting technique into the 3D imaging flow cytometry. In some embodiments, the system may comprise a cuvette that is positioned in the center of the system as depicted in FIG. 27. In some embodiments, the system may comprise a laser light introduced from the side of the cuvette through the cavitation Illumination Objective (I.O.) as depicted in FIG. 27. In such embodiments, the system is configured for creating bubbles in the cuvette by pulsed laser light. In some embodiments, the system comprises a laser light emitted through the imaging objective wherein the objective is positioned on top of the flow cell and configured to excite the sample (e.g., particle or cell). In some embodiments, the system is configured to collect side-scattering signals and fluorescent signals through the side Detection Objective (D.O.). In some embodiments, the system is configured to collect a 2D transmission signal through the forward detection (D.O.).

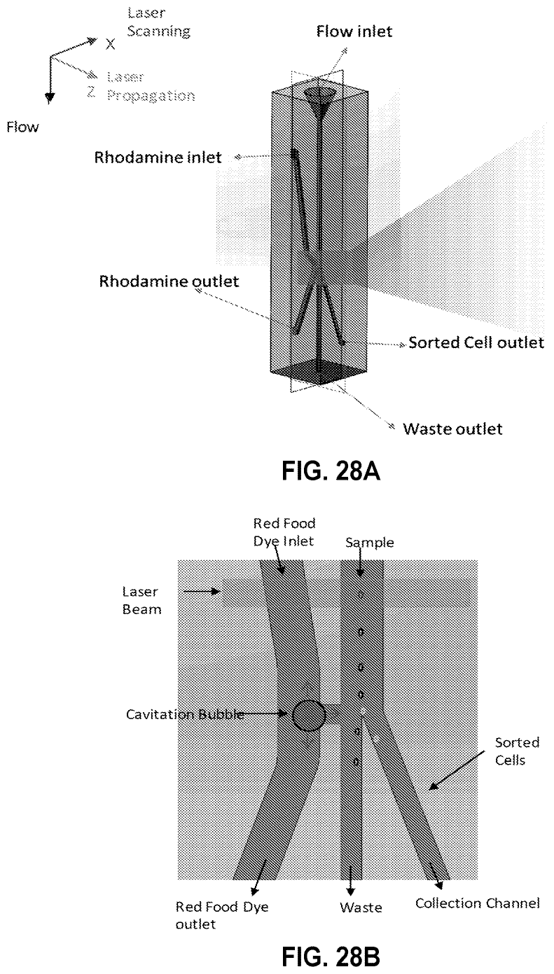

In some embodiments, the system comprises the cuvette as depicted in FIG. 28A. In some embodiments, the system comprises a cuvette comprising two main channels, where a first channel is configured for sample flow and a second channel is configured for a tracer solution (e.g., dye solution) as depicted in FIGS. 28A and 28B. FIG. 28B depicts a zoomed in view of the channel of the cuvette depicted in FIG. 28A, in accordance with some embodiments. In some embodiments, the sample flow channel may be divided into two sub-channels. In some embodiments, the two sub-channels may be configured for particle (e.g., cell or targeting cell) collection and waste collection. In some embodiments, the system may be configured for 3D hydrodynamically focusing the sample by the sheath flow in the sample flow channel. In some embodiments, the system may be configured for illuminating the sample by a scanning light sheet when the samples pass through the laser interrogation area. In some embodiments, the system may comprise a pulse laser configured for generating cavitation bubbles in the vicinity of the particle (e.g., cells) while the particle is passing the sorting junction if a sorting decision is determined (e.g., gating call, or gating signal, is determined) to sort the particle.

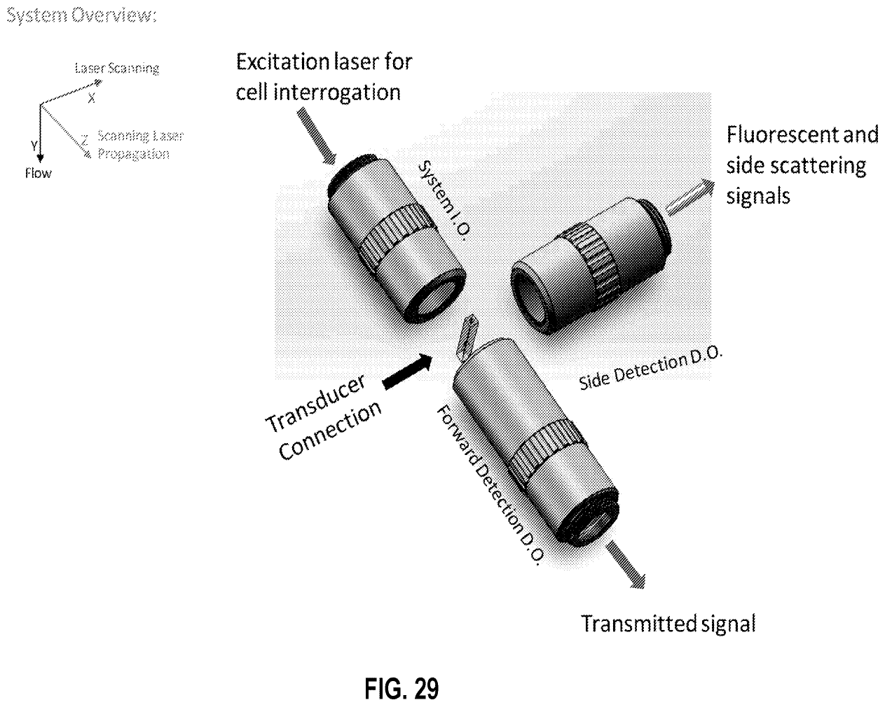

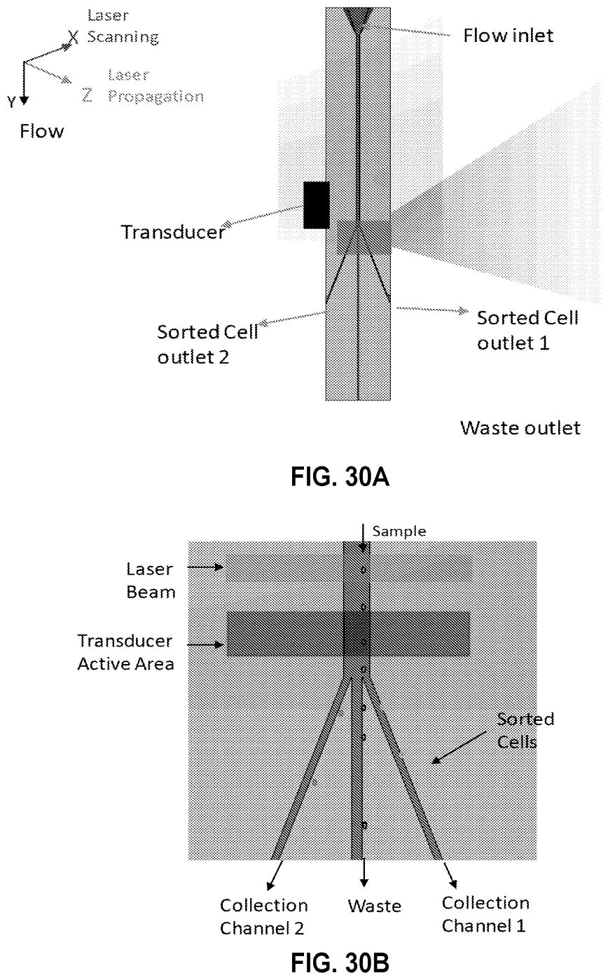

Described herein are various systems and devices for acoustic sorting. In some embodiments, the system comprises the acoustic sorting system as depicted in FIG. 29. In some embodiments, the system comprises a cuvette comprising an acoustic transducer connected on the left side of the cuvette as depicted in FIG. 30A. In some embodiments, the system comprises a light source and illumination objective. In some embodiments, light source is a laser light source. In some embodiments, the laser light source and illumination objective are configured to excite the sample (e.g., particle or cell). In some embodiments, the system comprises a side detection objective configured for collecting the 3D side-scattering signal and fluorescent signals. In some embodiments, the system comprises a forward detection objective configured for collecting the 2D transmission signal. FIG. 30A shows detailed design of a cuvette according to some embodiments. FIG. 30B depicts a zoom-in design of the sorting junction in accordance with some embodiments. In some embodiments, the system comprises a cuvette, as depicted inf FIGS. 30A and 30B, configured for three-way cell sorting. In some embodiments, the main flow channel is divided into 3-subchannels configured for 3-way cell sorting. In some embodiments, the flow channel comprises a sheath flow for 3D hydro-dynamically focusing the sample. In some embodiments, the system is configured to produce a scanning light sheet configured to illuminate the samples as the samples pass through the laser interrogation area. In some embodiments, the system comprises a cuvette where a transducer is attached to the side wall of the cuvette downstream to the laser interrogation area.

In some embodiments, the sorting module is configured for jet-in-air sorting. In some embodiments, the sorting module is configured for laser cavitation sorting. In some embodiments, the system is configured to sort at least about 10⁻⁴ seconds after the detection of the particle. In some embodiments, the system is configured to sort from about 10⁻⁴ seconds to about 10⁻¹ seconds after the detection of the particle.

### Methods

### Data Processing (Generating a Gating Call)

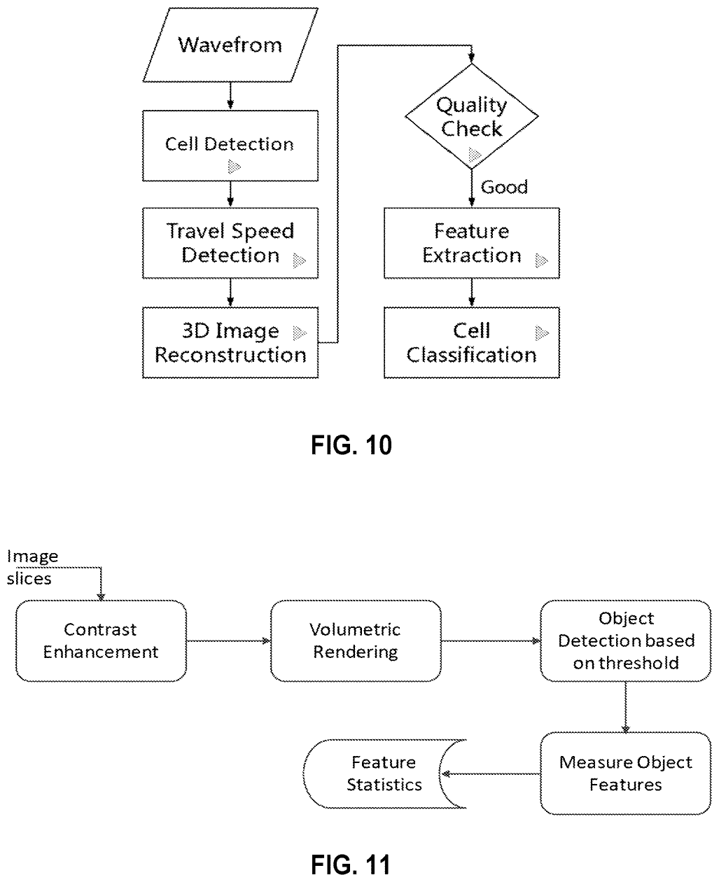

Described herein are various methods for generating a gating call. In some embodiments, such methods comprise generating the gating call based on image-based cell classification. In some embodiments, a method for generating a gating call comprises the steps of cell detection, feature extraction, cell classification, or a combination thereof. In some embodiments, a method for generating a gating call comprises the steps of cell detection, travel speed detection, feature extraction, cell classification, or a combination thereof. In some embodiments, a method for generating a gating call comprises the steps of cell detection, travel speed detection, image reconstruction, a quality check, feature extraction, cell classification, or a combination thereof. FIG. 10 shows a diagram of data processing algorithm in accordance with some embodiments.

Described herein are various methods for extracting feature statistics of particles (e.g., cells) from image slices (e.g. images, images of image stacks) of the particles. In some respects, a method for extracting feature statistics from image slices may comprise obtaining or providing image slices, enhancing the contrast of the image slices, rendering a volumetric image, detecting objects based on a threshold, measuring object features or a combination thereof. FIG. 11 depicts a process flow chart for a method for extracting feature statistics from image slices. Table 1 lists parameters that may be extracted from image slices originating from the fluorescence channel, the bright field channel. Table 1 also includes cross channel statistics. As an example, gating can be defined by the ratio of fluorescent volume obtained from the fluorescent detection channel and the total cell volume obtained from the side scattering detection channel.

TABLE 1

| Fluorescence | Bright Field | |
|---|---|---|
| Channel | Channel | Cross Channel |
| Volume | Volume | Volume(FL)/Volume (BF) |
| Surface | Surface | Membrane/nucleus contour |
| Center of mass | Center of mass | Colocalization |
| Centroid | Centroid | Compactness |
| Object Count | Object Count | Object Count |
| Distance to Objects | Distance to Objects | Distance to Objects |

### Jet-In-Air Sorting Method

In embodiments, sorting is accomplished by jet-in-air sorting as depicted in FIG. 26A. In some embodiments, the method comprises obtaining or providing a system comprising a nozzle, high voltage deflection plates, collection tubes, or a combination thereof. In certain aspects, the sample to be analyzed may be introduced into the nozzle and then 3D hydro-dynamically focused by the sheath flow. In some embodiments, the fluid stream may emerge from the nozzle outlet. In some embodiments, the samples may be illuminated by a scanning light sheet. In some embodiments, the samples may be illuminated by a scanning light sheet, where the samples pass through a laser interrogation area. FIG. 26B shows a detailed illumination and detection diagram, in accordance with some embodiments. In some embodiments, the sample density may be controlled such that only one particle (e.g., cell) is present in the laser illumination area at a given time. In some embodiments, wherein a single particle (e.g., cell) passes through the laser interrogation area, the three-dimensional (3D) side-scattering and fluorescent signals as well as the two-dimensional (2D) transmission signal may be collected simultaneously. Downstream to the laser interrogation area, in accordance with some embodiments, the fluid stream may be split into individual droplets the high-speed vibration of the nozzle, where the individual droplets may contain single particles (e.g., cells). In some examples, the collected signals may be analyzed, and the sorting decision may be generated before the droplet generation. In some embodiments, the droplets that contain the selected cells may be charged when the droplet is generated. In some embodiments, when the droplets pass through the deflection plates, droplets will be deviated to the desired collection tubes according to the charges applied at the break-off point. In some embodiments, for a simple 3-part sorting method, droplets that contain positive charges, no charge and negative charges may be separated into 3 different collection tubes. In some embodiments, the system may comprise greater than 3 collection tubes. In some embodiments, the system may comprise greater than 3 collection tubes, based on the charge amount that may be applied to the droplets.

### Laser Cavitation Sorting Method

Described herein are various methods for laser cavitation sorting. In some embodiments, the method comprises using the laser cavitation sorting system as depicted in FIG. 27. In some embodiments, the method comprises using a cuvette for coupling the laser cavitation bubble sorting technique into a 3D imaging flow cytometry system. In some embodiments, the method comprises using a cuvette that is positioned in the center of the system as depicted in FIG. 27. In some embodiments, the method comprises creating bubbles in the cuvette by pulsed laser light, where the laser light is introduced from the side through the cavitation Illumination Objective (I.O.) as depicted in FIG. 27. In some embodiments, the method comprises, interrogating a particle (e.g., cell) with excitation laser light introduced from the top through the system I.O. In some embodiments, the method, comprises collecting side-scattering signals and fluorescent signals through the side Detection Objective (D.O.). In some embodiments, the method comprises collecting a 2D transmission signal through the forward detection (D.O.).

In some embodiments, the method comprises obtaining or providing the cuvette as depicted in FIG. 28A. In some embodiments, the method comprises obtaining or providing, a cuvette comprising two main channels, a first channel configured for sample flow and a second channel configured for a tracer solution (e.g., dye solution) as depicted in FIGS. 28A and 28B. FIG. 28B depicts a zoomed in view of the channel of the cuvette depicted in FIG. 28A. In some embodiments, the sample flow channel may be further divided into two sub-channels for targeting cell collection and waste collection. In some embodiments, the method comprises 2D hydrodynamically focusing the sample by the sheath flow in the sample flow channel. In some embodiments, the method comprises illuminating the sample by a scanning light sheet when the samples pass through the laser interrogation area. In some embodiments, the method comprises collecting and analyzing the signals. In some embodiments, the method comprises extracting sample travel speed from the collected signal, which may be used to determine when the cavitation bubble may be generated. In some embodiments, the method comprises increasing the light absorption rate of the laser by flowing tracer solution (e.g., red food dye) the left flow channel as depicted in FIGS. 28A and 28B. In some embodiments, the method comprises vaporizing the liquid water rapidly via a focused laser pulse allowing expanding cavitation bubbles to generate rapidly. In some embodiments, the vapor pressure inside the cavitation bubbles will provide a force through the junction between the sample flow channel and the tracer flow channel (e.g., red food dye flow channel) to sort the samples to collection channel. In some embodiments, the method comprises firing the pulse laser to generate cavitation bubbles in the vicinity of the particle (e.g., cells) while the particle is passing the sorting junction if a sorting decision is determined (e.g., gating call, or gating signal, is determined) to sort the particle.

### Acoustic Sorting Method

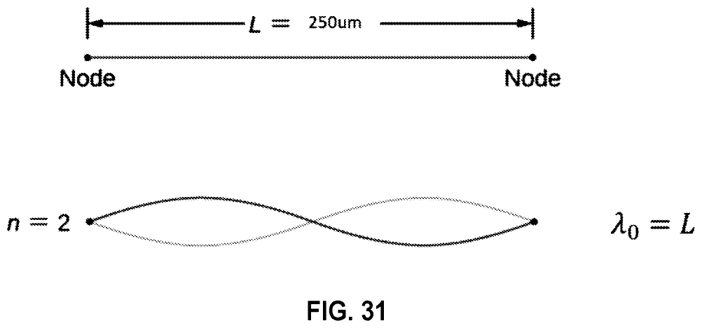

Described herein are various methods for acoustic sorting. In some embodiments, the method comprises providing or obtaining the overall configuration of the acoustic sorting system as depicted in FIG. 29. In some embodiments, the method comprises obtaining or providing a cuvette comprising an acoustic transducer connected and controlled from the left side as depicted in FIG. 30A. In some embodiments, the method comprises interrogating the particle (e.g., cell) with excitation laser light, wherein the excitation laser light may be introduced from the top through the system illumination objective (e.g., IO). In some embodiments, the method comprises collecting the 3D side-scattering signal and fluorescent signals through the side Detection Objective (e.g., DO). In some embodiments, the method comprises collecting the 2D transmission signal through the forward detection (D.O.). FIG. 30A shows a detailed design of a cuvette according to some embodiments. FIG. 30B depicts a zoom-in design of the sorting junction. In some embodiments, the method comprises obtaining or providing the cuvette as depicted inf FIGS. 30A and 30B for three-way cell sorting. In some embodiments, the main flow channel is divided into a 3-subchannel for 3-way sorting. In some embodiments, the method comprises 3D hydro-dynamically focusing the sample by the sheath flow in the sample flow channel. In some embodiments, the method comprises illuminating the samples by a scanning light sheet when the samples pass through the laser interrogation area. In some embodiments the method comprises collecting and analyzing the signals. In some embodiments, the method comprises extracting sample travel speed from the collected signal, where the sample speed may be used to determine when acoustic sorting may be activated. In some embodiments, the method comprises obtaining or providing a cuvette where the transducer may be attached to the side wall of the cuvette, downstream to the laser interrogation area. In some embodiments, the method comprises directing samples to different sorting channels via a RF driving frequency emitted by the transducer to shift the nodal points of a standing wave inside the sample flow channel. In some embodiments, the method comprises activating the transducer and fine tuning the RF driving frequency of the transducer such that the nodal point of the standing wave may be shifted toward the sorting channel and the targeted cells may be directed to the sorting channel. FIG. 31 depicts the wavelength parameters of an RF driving waveform.

Described herein are various embodiments of a method for particle sorting, the method comprising: providing a sorting system comprising: a flow cell configured to allow a particle to move in a flow path in a flow direction; a sorting module fluidly connected to the flow cell; an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; a detection module comprising a spatial filter, the spatial filter comprising: a front surface; a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and a data processing module configured to generate a gating signal using the time-dependent signal; and loading a sample comprising the plurality of particles into the system; and initiating the system, and wherein, the sorting module is configured to sort the particle in response the gating signal.

Described herein are various embodiments, of a method for cell sorting, the method comprising: flowing a particle along a flow path through a flow cell in a flow direction; illuminating the particle via scanning a light beam in a scanning direction, the scanning direction about perpendicular to the flow direction, the light beam propagating in a light propagating direction about orthogonal to a plane comprising the flow direction and the scanning direction; detecting the particle, wherein light having interacted with the particle transmits through an aperture of a plurality of apertures of a spatial filter, the plurality of apertures arranged in a line comprising a tilting angle with the flow direction, wherein the detection module is configured to generate a time-dependent signal upon detection of the particle, wherein the time-dependent signal correlates to a particle feature of the particle; generating a gating signal based on aspects of the particle feature; and sorting the particle based on the gating signal.

Described herein are various embodiments of an automated data processing method for flow cytometry gating, the method comprising: obtaining a time-dependent signal; generating intensity statistics; and determining a gating signal. In some embodiments, the method further comprises parsing the time-dependent signal.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Computer

Implementations of the subject matter and the functional operations described in this patent document and attached appendices may be implemented in various systems, digital electronic circuitry, or in computer software, firmware, or hardware, including the structures disclosed in this specification and their structural equivalents, or in combinations of one or more of them. Implementations of the subject matter described in this specification may be implemented as one or more computer program products, i.e., one or more modules of computer program instructions encoded on a tangible and non-transitory computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus m a y include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory may be supplemented by, or incorporated in, special purpose logic circuitry.

### EXAMPLES

The following illustrative examples are representative of embodiments of systems and methods described herein and are not meant to be limiting in any way.

### Example 1: Jet-In-Air Sorting

FIG. 26A depicts the process of jet-in-air sorting method. The system includes a special designed nozzle, high voltage deflection plates and subsequent collection tubes. The sample to be analyzed is introduced into the nozzle and then 2D hydro-dynamically focused by the sheath flow. The fluid stream then emerges from the nozzle outlet. The samples are illuminated by a scanning light sheet when the samples pass through the laser interrogation area. FIG. 26B shows a detailed illumination and detection diagram. The sample density is controlled such that only one cell is present in the laser illumination area at one time (e.g., detection event time). When the single cell passes through the laser interrogation area, the three-dimensional (3D) side-scattering and fluorescent signals as well as the two-dimensional (2D) transmission signal are collected simultaneously. Downstream to the laser interrogation area, the fluid stream is split into individual droplets, each droplet containing a single cell, via the high-speed vibration of the nozzle. The collected signals are analyzed, and the sorting decision is generated before the droplet generation. The droplets that contain the selected cells are charged when the droplet is generated. When the droplets pass through the deflection plates, droplets are deviated to the desired collection tubes according to the charges and the polarity of the applied voltage at the break-off point. For a simple 3-part sorting, droplets that contain positive charges, no charge and negative charges are separated into 3 different collection tubes by voltage pulses of positive or negative polarity.

### Example 2: Laser Cavitation Sorting

FIG. 27 shows the overall configuration of the laser cavitation sorting system. A special designed cuvette is used for coupling the laser cavitation bubble sorting technique into the 3D imaging flow cytometry. The cuvette is located in the center of the system. Pulse laser light for the sorting bubble creation is introduced from the side through the cavitation Illumination Objective (I.O.). The excitation laser light for cell interrogation is introduced from the top through the system I.O. The 3D side-scattering signal and fluorescent signals are collected through the side Detection Objective (D.O.). The 2D transmission signal is collected through the forward detection (D.O.). FIG. 28B shows the detailed design of the cuvette. The cuvette includes two main channels, a first channel for sample flow and a second channel for red food dye flow or any component that possesses high absorption to the pulse laser beam (e.g., 532 nanometer wavelength Q-switched pulsed laser). A zoom-in design of the sorting junction is included in FIG. 28C. The sample flow channel is further divided into two sub-channels for targeting cell collection and waste collection. The sample is 2D hydrodynamically focused by the sheath flow in the sample flow channel. The samples are illuminated by a scanning light sheet when the samples pass through the laser interrogation area. The signals are collected and analyzed. Sample travel speed is extracted from the collected signal, which is used to determine when the cavitation bubble will be generated. Red food dye is flown in the left channel (e.g., red food dye channel). The red food dye is used to increase the light absorption rate of the pulse laser. A focused laser pulse vaporizes the liquid water rapidly which generates rapidly expanding cavitation bubbles. The vapor pressure inside the cavitation bubbles provides a force through the junction between the sample flow channel and the red food dye flow channel to sort the samples to collection channel. Knowing that the pre-set distance between the laser interrogation area and the sorting junction allows for the pulse laser to be fired when the target cells pass the sorting junction if a sorting decision is determined (e.g., gating signal indicating which channel the particle is to be sorted to). Generating cavitation bubbles allow for the target cells to be sorted to the collection channel. Not generating cavitation bubbles allows for non-target cell particles to be sorted to the waste channel.

### Example 3: Acoustic Sorting

FIG. 29 shows the overall configuration of the acoustic sorting system. FIGS. 30A and 30B show cross sectional views of the flow cell in the acoustic sorting system. The transducer is connected and controlled from the left side. The excitation laser light for cell interrogation is introduced from the top through the system I.O. The 3D side-scattering signal and fluorescent signals is collected through the side Detection Objective (D.O.). The 2D transmission signal is collected through the forward detection (D.O.). FIG. 30B depicts a zoom-in design of the sorting junction. The main flow channel is divided into 3-subchannel for 3-way cell sorting. The sample is 2D hydro-dynamically focused by the sheath flow in the sample flow channel. The samples are illuminated by a scanning light sheet when the samples passthrough the laser interrogation area. The signals are collected and analyzed. Sample (e.g., particle or cell) travel speed is also extracted from the collected signal, which is used to determine when the acoustic sorting will be activated. Downstream to the laser interrogation area, the transducer is attached to the side wall of the cuvette. Varying the RF driving frequency of the transducer shifts the nodal points of the standing wave inside the sample flow channel which directs samples to different sorting channel based on sorting decisions (e.g., gating signals). When the sorting decision is determined, the transducer activates and the RF driving frequency of the transducer is fine-tuned such that the nodal point of the standing wave is shifted toward the sorting channel and the targeted cells are directed to the sorting channel.

The following is a calculation of the RF driving frequency.

The speed of sound in PBS:

$$v = 1500 meters / second$$

### Channel Width:

$$W = 250 microns$$

Standing wave nodal point at the channel center:
λ₀: Acoustic wavelength to produce a nodal point at the center of the channel.

Assume the standing wave is established between two walls of the cuvette and the reflection between the water/quartz interface is negligible:

The thickness between the center of the channel and the left wall of the cuvette:

$${W}_{L} = {N}_{L} \frac{{λ}_{0}}{2}$$

(N_{L} is a positive integer)

The thickness between the center of the channel and the right wall of the cuvette:

$${W}_{R} = {N}_{R} \frac{{λ}_{0}}{2}$$

(N_{R} is a positive integer)

Assume that to sort the cells, we need to move the nodal point from the center of the channel to the left by a distance Δ by changing the frequency of the acoustic wave,

Assume the new acoustic wave has a different wavelength λ′ from λ₀,

We assume

$${W}_{L}^{′} = ( {N}_{L} + m ) \frac{{λ}^{′}}{2}$$

where W′_{L} is the distance between the new nodal point and the left wall of the cuvette. m is an integer.

We assume

$${W}_{R}^{′} = ( {N}_{R} + n ) \frac{{λ}^{′}}{2}$$

where W′_{L} is the distance between the new nodal point and the right wall of the cuvette. n is an integer.

Since W′_{L}+W′_{R}=W_{L}+W_{R}, we have (N_{L}+N_{R})λ₀=(N_{R}+N_{L}+m+n)λ′

We have

$${λ}^{′} = {λ}_{0} \frac{{N}_{L} + {N}_{R}}{{N}_{R} + {N}_{L} + m + n} .$$

Assume a distance of 8.25 millimeters between two walls of the cuvette.

The acoustic frequency, f₀, that produces a nodal point at the center of the channel is 6 MHz.

$${λ}_{0} = \frac{v}{{f}_{0}} = 250 microns$$

$${N}_{R} = {N}_{L} = \frac{8.25}{{λ}_{0}} = \frac{8.25}{0.25} = 33$$

If we choose m=19, n=20, the new acoustic wavelength λ′ and λ₀ have the following relation:

$${λ}^{′} = {λ}_{0} \frac{{N}_{L} + {N}_{R}}{{N}_{R} + {N}_{L} + m + n} = 250 \times \frac{66}{105} = 157 ( microns )$$

The new acoustic frequency

$${f}^{′} = \frac{v}{{λ}^{′}} = 9.56 ( MHz )$$

At this frequency, the nodal position is shifted by a distance Δ towards the left wall,

$$Δ = {N}_{L} \frac{{λ}_{0}}{2} - ( {N}_{L} + m ) \frac{{λ}^{′}}{2} = \frac{{λ}_{0}}{2} ( \frac{{N}_{L} n - {N}_{R} m}{{N}_{R} + {N}_{L} + m + n} ) = 24.7 ( microns )$$

In this design example, the particle at the center of the channel can be moved to the new position that is 24.7 μm left to the center of the channel when the acoustic frequency changes from 6 MHz to 9.56 MHz.

### Setup:

The standard cuvette is a 4 millimeters by 4 millimeters square and the flow channel is 250 microns by 250 microns square in the center of the cuvette. The Acoustic Transducer will be attached to the side wall of the cuvette. The relationship of nodal points and the operation frequencies are calculated for the center of the rectangle flow channel.

A wave comprising a wavelength of 250 microns is depicted FIG. 31.

### Example 4: Calculating Tilt Angle of Forward Spatial Filter

FIG. 19A shows a forward spatial filter (FSP) 1521 as viewed head-on from the laser propagation direction (Z-axis). A coordinate diagram is shown to the left, denoting the orientation of the FSP 1521 within the system 1500.

FIG. 19B shows a schematic of the FSP 1521 and PMT array 1905 configured for acquiring multiple 2D transmission images at different focal planes. The forward detection PMT array 1905 is aligned with projected light from the slits 1702 of the FSP 1521. Each PMT 1906 detects only the light passing a single slit 1702. The FSP 1521 is oriented at an angle, θ, 1907 from the axis of flow (e.g., Y-axis). In this example, the laser beam transmits through the particle (e.g., cell) 1903 and through each slit 1702 of the FSP 1521 creating a transmitted beam corresponding to each slit 1702. Each PMT 1906 of the PMT array 1905 is positioned to collect only the light from the corresponding slit. This results each PMT 1906 of the PMT array 1905 to image only light being transmitted through the corresponding focal plane 1901 of the particle 1903 as it travels along the flow direction (Y-axis). 1, 2, 3, and 4 are focal planes on the cell and 1′, 2′, 3′, 4′ the conjugate planes. For example, as shown in FIG. 19B, the system is configured such that PMT1 1906 acquires image 1 of a particle feature 1904 of the particle 1903, at a focal plane 1 1901, and at time point 1 when the particle 1903 is at position 1 in the flow path (Y-axis). PMT2 acquires image 2 of focal plane 2 at time point 2 when the particle 1903 is at position 2 in the flow path (Y-axis). PMT3 acquires image 3 of focal plane 3 at time point 3 when the particle 1903 is at position 3 in the flow path (Y-axis). PMT4 acquires image 4 of focal plane 4 at time point 4 when the particle 1903 is at position 4 in the flow path (Y-axis). Only focal plane 1 1901 and conjugate plane 1 1902 are shown for simplicity. Stacking of images 1-4, each acquired at different focal planes 1901, creates a composite 2D image with extended focal depth. In this example the method is referred to a focus stacking.

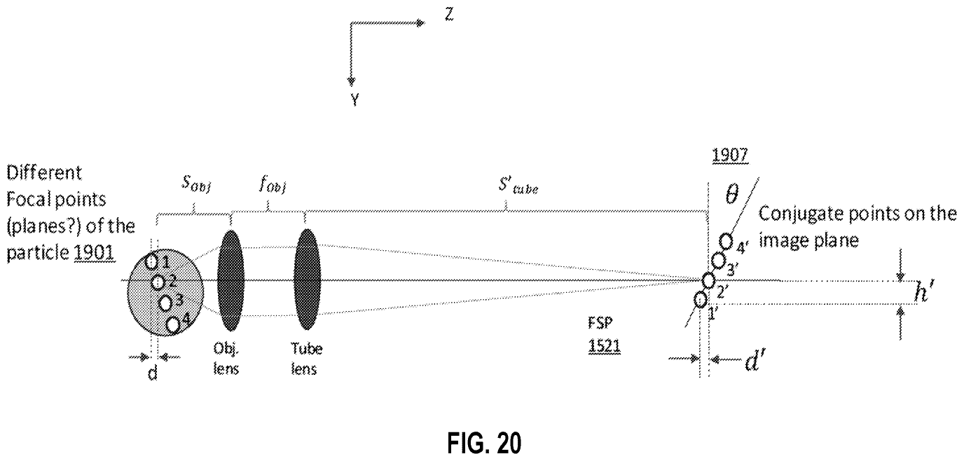

FIG. 20 shows a ray tracing diagram for the forward detection system 1504 comprising: the particle (e.g., cell) 1903; four focal planes 1901 (e.g., 1, 2, 3 and 4) 1901 within the particle, where d is the width of the focal plane; the objective lens; and the lens tube and the forward spatial filter FSP 1521. In this example, each conjugate plane 1902 (e.g., 1′, 2′, 3′ and 4′) are shown, h′ is the is the distance between the conjugate planes along the Y axis and d′ is the width of the conjugate plane on the image plane. As depicted in FIG. 20 the forward spatial filter (FSP) 1521 is shown tilted at an angle, θ, 1907 relative to the axis of flow, Y. θ 1907 is defined and calculated by the following, where S_{obj} refers to the object distance of 1901 (plane 2). F_{obj} refers to the focal length of the objective lens. S′_{tube} refers to the image distance between the tube lens and 1907 (plane 2′). In some embodiments, calculation of the angle θ, 1907, uses the thin lens approximation. For the in-focus case:

of the FSP 1521 for 2D focus stacking may be:

### In-Focus Case:

$$Obj . lens : \frac{1}{{S}_{Obj}} + \frac{1}{{S}_{Obj}^{′}} = \frac{1}{{f}_{Obj}} , {S}_{Obj}^{′} \to ∞ , {S}_{Obj} = {f}_{Obj}$$

$$Tube lens : \frac{1}{{S}_{tube}} + \frac{1}{{S}_{tube}^{′}} = \frac{1}{{f}_{tube}} , {S}_{tube} = {S}_{Obj}^{′} + {f}_{Obj} , {S}_{tube} \to ∞ , {S}_{tube}^{′} = {f}_{tube}$$

Object distance offset by d, d<<f_{obj}

$$Obj . lens : \frac{1}{{S}_{Obj} + d} + \frac{1}{{S}_{Obj}^{′}} = \frac{1}{{f}_{Obj}} , \frac{1}{{S}_{Obj}^{′}} = \frac{1}{{f}_{Obj}} - \frac{1}{{S}_{Obj} + d} , \\ \frac{1}{{S}_{Obj}^{′}} = \frac{1}{{f}_{Obj}} - \frac{1}{{f}_{Obj} + d} , {S}_{Obj}^{′} ≫ {f}_{Obj}$$

$$Tube lens : \frac{1}{{S}_{tube}} + \frac{1}{{S}_{tube}^{′}} = \frac{1}{{f}_{tube}} , \\ {S}_{tube} = {S}_{Obj}^{′} + {f}_{Obj} , as {S}_{Obj}^{′} ≫ {f}_{Obj} , let {S}_{tube} ∼ {S}_{Obj}^{′} ,$$

$$Thus \frac{1}{{S}_{tube}^{′}} = \frac{1}{{f}_{tube}} - \frac{1}{{f}_{Obj}} + \frac{1}{{f}_{Obj} + d}$$

$$θ = {tan}^{- 1} ( \frac{{d}^{′}}{{h}^{′}} )$$

$$Since {f}_{Obj} ≫ d , and$$

$$\frac{1}{{S}_{tube}} = \frac{1}{{f}_{tube}}$$

$$\frac{1}{{S}_{tube}^{′}} = \frac{1}{{f}_{tube}} - \frac{1}{{f}_{Obj}} + \frac{1}{{f}_{Obj} + d} = \frac{1}{{S}_{tube}} - [ \frac{d}{{f}_{Obj} ( {f}_{Obj} + d )} ] ≅ \frac{1}{{S}_{tube}} - [ \frac{d}{{f}_{Obj}^{2}} ]$$

$$\frac{1}{{S}_{tube}} - \frac{1}{{S}_{tube}^{′}} = \frac{{S}_{tube}^{′} - {S}_{tube}}{{S}_{tube} {S}_{tube}^{′}} ≅ \frac{{S}_{tube}^{′} - {S}_{tube}}{{S}_{tube}^{2}} ≅ \frac{{d}^{′}}{{S}_{tube}^{2}} ≅ [ \frac{d}{{f}_{Obj}^{2}} ]$$

$${d}^{′} = \frac{{S}_{tube}^{2}}{{f}_{Obj}^{2}} d ≅ ( \frac{{f}_{tube}^{2}}{{f}_{Obj}^{2}} ) d$$

In this example, f_{tube}=40 millimeters, f_{Obj}=4 millimeters. Choose d=2.5 microns
then d=250 microns

Similarly,

$${h}^{′} ≅ ( \frac{{f}_{tube}^{2}}{{f}_{Obj}^{2}} ) h$$

h: distance between adjacent focal planes. Choose h to be 2 um, then h′=200 microns

Then

$$θ = {tan}^{- 1} ( \frac{{d}^{′}}{{h}^{′}} ) = {tan}^{- 1} ( \frac{d}{h} ) = {tan}^{- 1} ( \frac{d}{h} ) = {tan}^{- 1} ( \frac{2.5}{2.} ) = 51 °$$

50× Mitutoyo Obj., f_{Obj}=4 millimeters, actual magnification

$$M = \frac{{f}_{tube}}{{f}_{Obj}}$$

To achieve 10× magnification at the image plane, f_{tube}=40 millimeters, for ±10 microns depth offset with 2.5 microns depth step and 20 microns sagittal step

TABLE 2
Image distance estimation with tilted slit configuration
f_{—}_{obj} 4
f_{—}_{tube} 40
part

| | Slit effective | Slit vertical | |
|---|---|---|---|
| | vertical position | position on | |
| Effective object | on object plane | image plane | |
| distance to Obj. | w.r.t. principal | with respect to | Image distance to |
| lens | axis | principal axis | tube lens (S′_{tube}) |
| 4.01 | 0.08 | 0.8 | 41.02302 |
| 4.0075 | 0.06 | 0.6 | 40.76287 |
| 4.005 | 0.04 | 0.4 | 40.50569 |
| 4.0025 | 0.02 | 0.2 | 40.25141 |
| 4 | 0 | 0 | 40 |
| 3.9975 | −0.02 | −0.2 | 39.7514 |
| 3.995 | −0.04 | −0.4 | 39.50556 |
| 3.9925 | −0.06 | −0.6 | 39.26245 |
| 3.99 | −0.08 | −0.8 | 39.022 |

$$\frac{1}{{S}_{tube}^{′}} = \frac{1}{{f}_{tube}} - \frac{1}{{f}_{Obj}} + \frac{1}{{f}_{Obj} + d}$$

$$θ = arc tan ( \frac{1}{slope} ) ≅ 51.354 degrees$$

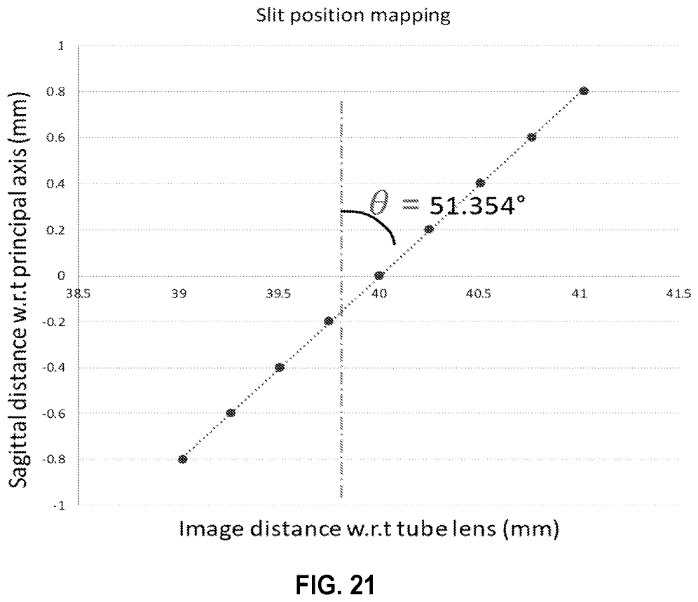

FIG. 21 plots sagittal distance with respect to the principal axis in millimeters versus the image distance with respect to the tube lens in millimeters. As seen in the plot, the tilt angle of the forward spatial filter, θ, in degrees, is calculated to be 51.354 degrees.

### Example 5: 3DIFCS/2D-Trans-IFC Detection and Acoustic Sorting System

The purpose of this example is to describe a sorting system including three-dimensional imaging flow cytometry (3D IFC), two-dimensional transmission imaging flow cytometry (2D-trans-IFC) and tilted spatial filters. In this example, an 3D IFC/2-trans-IFC system 1500 as depicted in FIG. 15, coupled with an acoustic sorting system as depicted in FIGS. 29, 30A, 30B, and 31 is described.

In this example, a 2D hydrodynamically focused sample flow establishes a single-cell stream with a sample concentration of ˜500 samples/micro liter. When a cell or bead passes through the laser interrogation area, it is illuminated by a scanning light-sheet at a 200 kHz scanning rate. A spatial filter placed at the image plane contains a series of spatially positioned pinholes aligned with the cell flow direction (Y-axis) by a predetermined separation. The emitted light from a specific portion of a cell is detected by photomultiplier tubes (PMTs). The spatial-temporal transformation is applied to reconstruct the 3D tomographic images. The forward spatial filter contains a long slit aligned with the laser scanning range. The transmitted light is collected by a PMT and the signal may produce a 2D transmission image. In this camera-less design, incorporating a scanning light-sheet and spatial masks, the 3D IFC system produces 3D side scattering and fluorescent images plus 2D transmission images of traveling cells at a rate of 1000 cells per second.

This example describes the components of the optical system schematics as depicted in the system diagram of FIG. 15. In this diagram, the AOD scanning direction (X-axis) is depicted as the horizontal axis, the laser propagation axis (Z axis) as the vertical axis, and the flow axis (Y-axis) as orthogonal to a plane comprising both the X and Y axes. In this example, a 488 nanometers laser is used as the light source 1505. The laser light is transmitted through the acoustic optical deflector 1506, two lenses 1507, a cylindrical lens 1508 and a 20× illumination objective (IO) 1509 before passing through the flow cell 1502. Fluorophore labeled particles (e.g., cells) emit fluorescence upon excitation by the light source.

The emitted fluorescence light is then collected through a 10× detection objective lens (DO) 1510, passes through a tube lens (f=200 millimeters) 1543, and the side detection spatial filter 1512. A 10/90 beam splitter 1513 directs light to a side detection monitoring camera 1514. The 90 percent remaining light is then directed to a first dichromatic mirror 1515, a 506LP dichromatic mirror 1515 where a portion of the light is collected as side scatter light by first PMT 1517. The reminder light is then directed to a second dichromatic mirror (620LP DM) 1544 allowing for a portion of the light to be filtered by an emission band pass filter 1519, a focusing lens 1507 and then detected as first fluorescence channel by a second PMT 1517. The remaining light passing through the second dichromatic mirror 1544 passes through a second emission band pass filter 1519, a second focusing lens 1517 and is detected as a second fluorescence channel by a second PMT 1517.

In this example, 488 nanometer laser light transmitted through the particle traveling through the flow cell 1502 detection region, is collected by a 50× detection objective, adjusted to an effective magnification of 10×, via the use of a tube lens (f=40 millimeters) 1520. The image plane 1511 is projected onto the tilted, forward spatial filter (FSP) 1521. Light transmitted through the FSP 1521 is transmitted through a lens (f=19 millimeters) 1522 and onto a 90:10 reflection/transmission (R:T) beam splitter 1523. The reflected light is transmitted through a lens (f=275 millimeters) 1524 and onto a 506 LP DM 1525. A portion of the light shown onto the 506 LP DM 1525 is reflected to a dielectric mirror 1527, transmitted through a cylindrical lens (f=75 millimeters) 1528, through a 488/10 band pass filter 1529 and a 30D neutral density filter 1530 and is detected by an 8×1 PMT array 1531. Light that is transmitted through the 506 LP DM 1525 is transmitted through a lens (f=125 millimeters) 1532, a 500 LP filter 1533 and onto a 562 LP DM 1545. Light reflected off the 562 LP DM 1545 is transmitted through a lens 1507 and a band pass filter 1519 and collected by a PMT 1517. Light that transmits through the 90:10 RT beam splitter 1523 then transmits through a lens (f=50 millimeters) 1535 and onto a dielectric mirror 1527. Light reflected off the dielectric mirror is transmitted through a lens (f=30 millimeters) 1540, through a 500 LP filter 1541, through a lens (f=30 millimeters) 1542 and is detected by a forward monitoring camera 1514. The FSP 1521 lies within the AOD scanning direction (X-axis) and flow direction (Y axis) allowing for laser light propagating in the Z-axis to transmit through its slits. FIG. 16A shows a schematic of the side spatial filter 1512. The SSP 1512 front profile as shown in FIG. 16A, lies within a plane comprising the Y-axis and Z-axis. The SSP 1512 is configured to allowing for light emitted by the particles (e.g., side scatter or epifluorescence) traveling in the secondary light propagating direction (e.g., primary scanning direction, X, or X-axis) to pass through the apertures (e.g., pinholes) 1601. In some embodiments, a plurality of apertures are arranged in a line comprising a tilting angle with the flow direction (e.g., Y or Y-axis). In some embodiments, the apertures (e.g., pinholes) are aligned in a direction referred to as the aperture axis direction 1602. The angle between the aperture axis direction (e.g., line of apertures) 1602 and the flow direction (Y-axis), as depicted in FIG. 16A, is referred to as the aperture (e.g., pinhole) tilt angle, ϑ, 1604. FIG. 16B shows resultant focal planes that result when the laser beam is scanned and transmitted through a corresponding aperture (e.g., pinhole) 1601. In some embodiments, the translation of the light scanning sheet across the particle in the primary light propagating direction (Z-axis) as the particle flows along the flow path (Y axis) enables scanning of the particle in three-dimensions.

### Spatial Filter-Forward Slit Dimension Calculation:

Aperture (e.g., pinhole or slit) Size: (M_{obj}*FOVₓ)*(M_{obj}*FOV_{y}/N_{y})
Aperture (e.g., pinhole or slit) Number: N_{y} (required sampling points along flow direction, Y-axis)
Aperture (e.g., pinhole or slit) pitch: M_{obj}*FOV_{y}*cos θ

### Spatial Filter-Side Slit Dimension Calculation:

Vertical center-center pitch: M_{obj}*FOV_{y}

### Horizontal Center-Center Pitch:

aperture (e.g., pinhole or slit) dimension: M_{obj}*FOVₓ/N_{y}

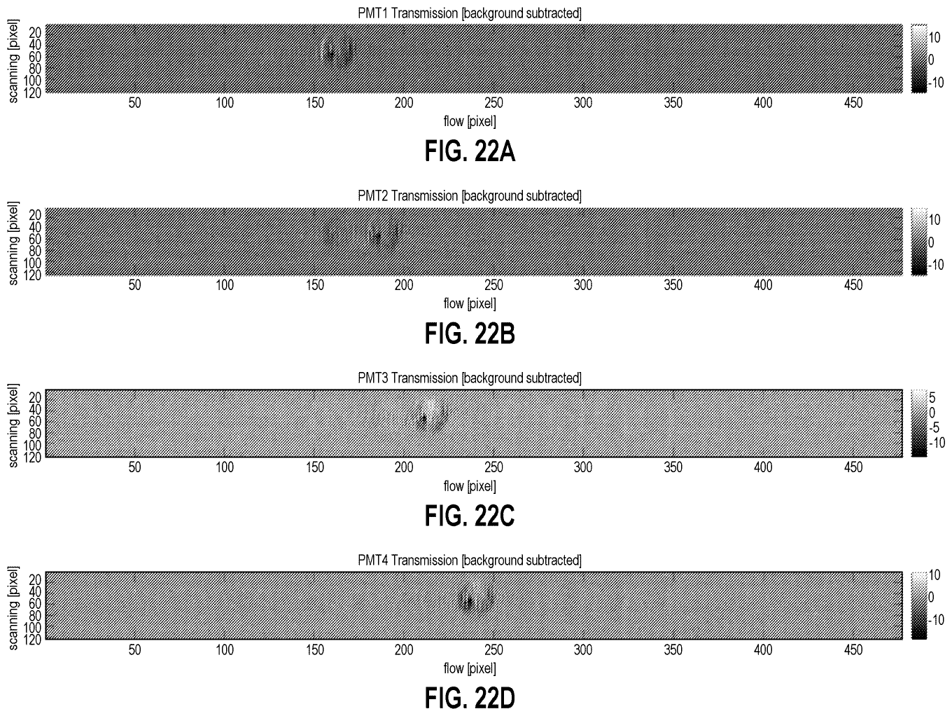

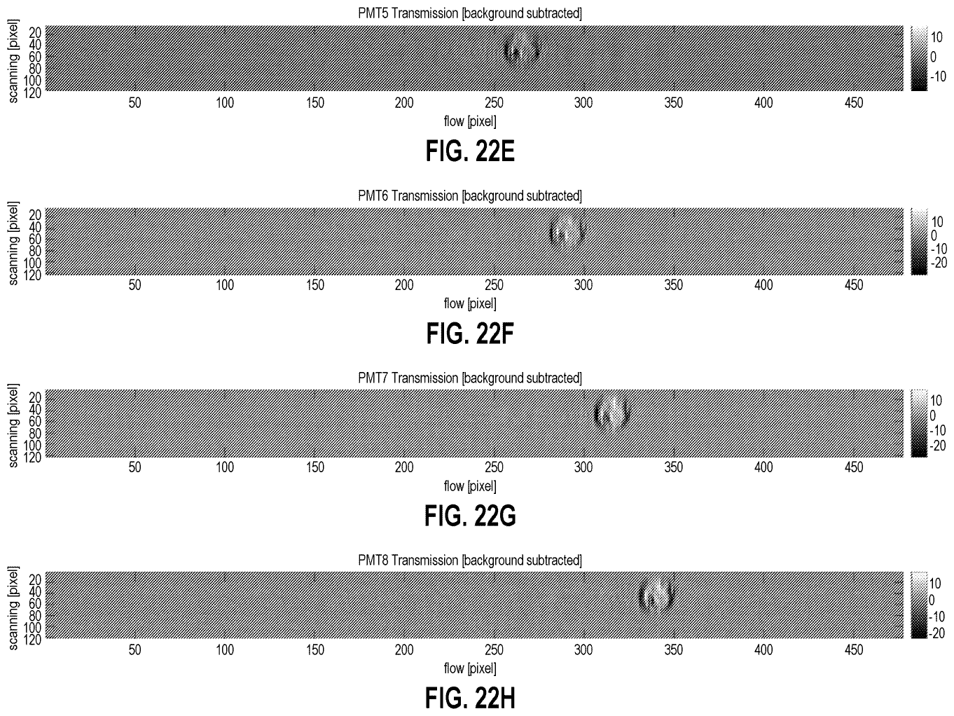

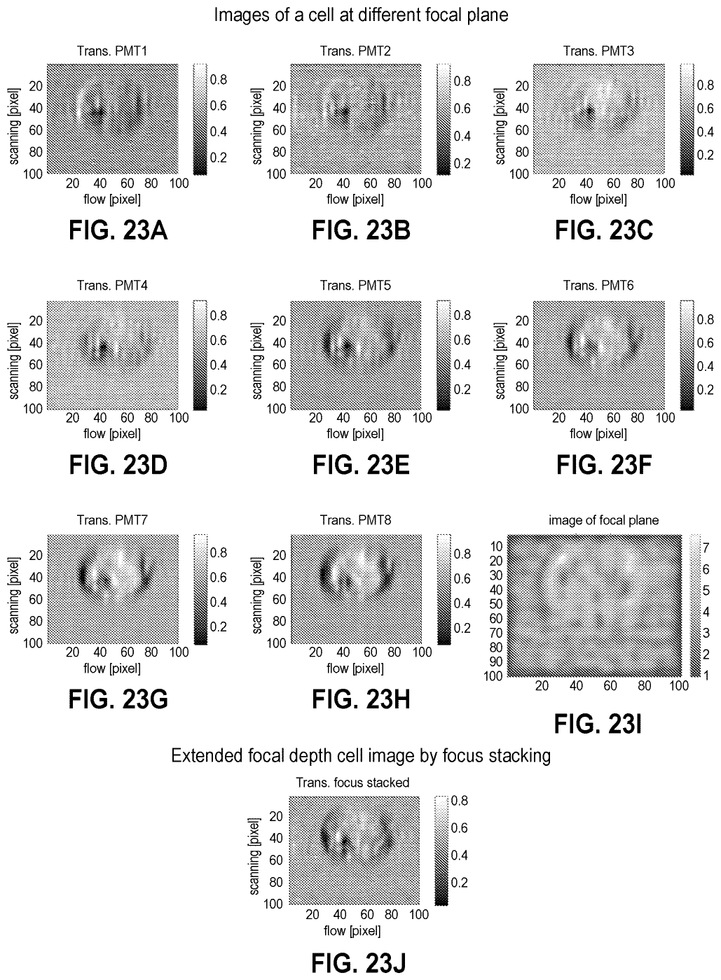

FIGS. 22A-H shows images of a cell at different focal planes as acquired by the system described in this example. FIGS. 23A-H show zoomed-in images of those shown in FIG. 22A-H. FIG. 23I depicts the pixel intensity focal plane selection map. FIG. 23J depicts a transmission focus stacked image.

FIGS. 24A-H shows images of a cell (different than the one shown in FIGS. 22A-H and 23A-J) at different focal planes as acquired by the system described in this example. FIGS. 25A-H show zoomed-in images of those shown in FIG. 24A-H. FIG. 251 depicts the pixel intensity focal plane selection map. FIG. 25J depicts a transmission focus stacked image.

In this example, a gating call is generated by the speed of the intensity gradient change. The gate selects the focal plane with the highest gradient change speed as the most in-focus focal plane for the focus stacking algorithm.

In this example sorting is carried out by an acoustic sorting mechanism as depicted in FIG. 29. The sorting process involves, illuminating a particle (e.g., cell) as it flows through the flow cell 1502 with the laser light as described in this example. Fluorescent and side scattering signals are collected, and a gating call is determined. The gating call signal is then sent to the acoustic transducer to actuate sorting of the particle to either outlet 1 or outlet 2 as depicted in FIG. 30A and FIG. 30B. In this example, wavelength parameters of the acoustic signal used to sort the cell are depicted in FIG. 31.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

### Example 6: Imaging Flow Cytometer Epi-Fluorescence Configuration

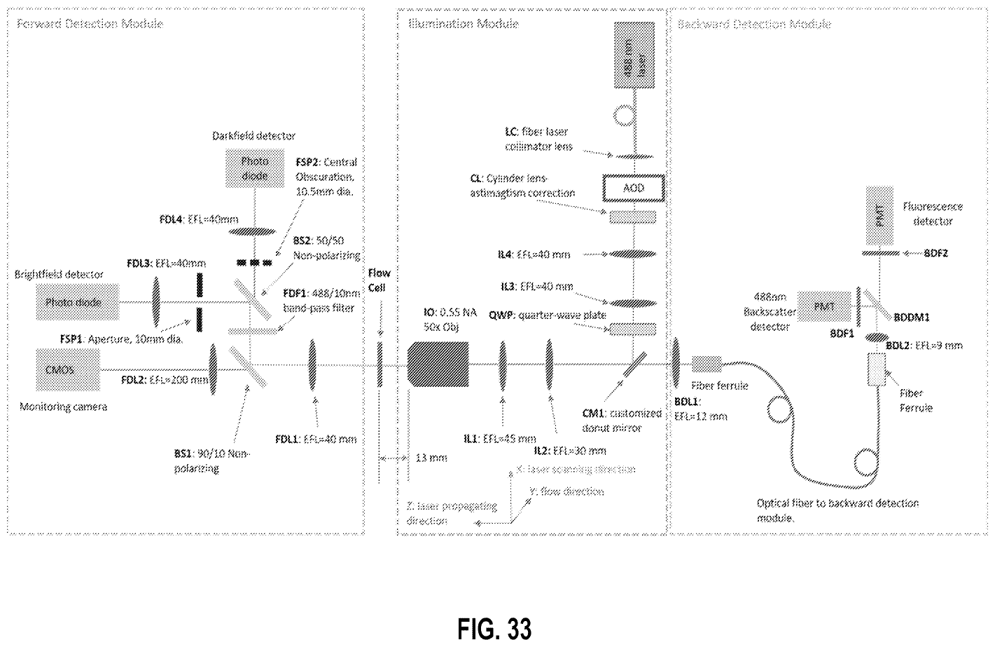

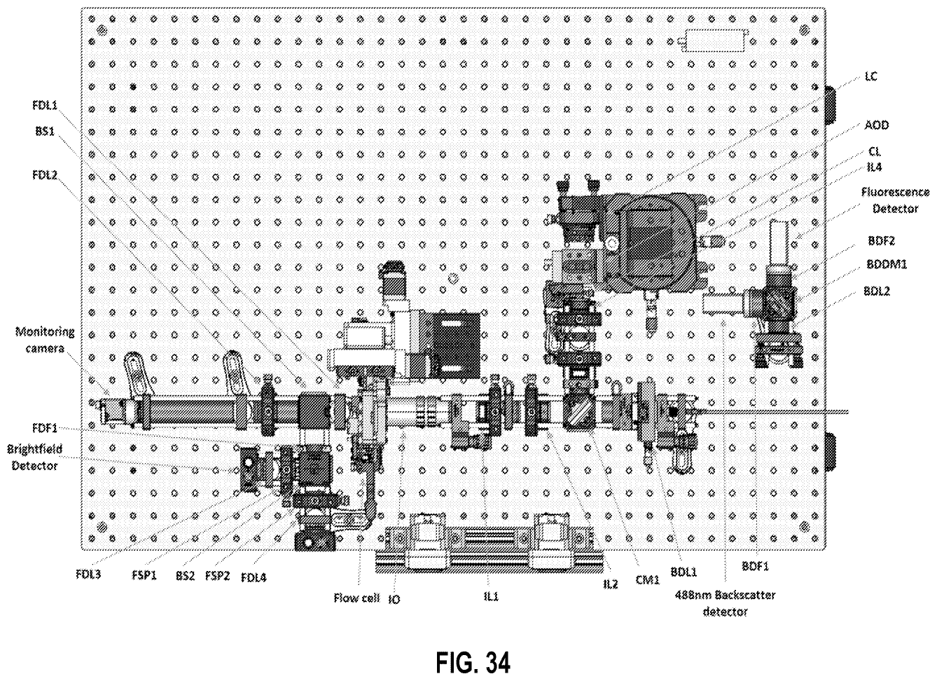

FIGS. 33 and 34 provide an optical schematic (FIG. 33) and an optomechanical layout (FIG. 34) of an example imaging flow cytometer system under epi-fluorescence configuration. In this example, the system contains three optical modules: illumination, forward detection and backward detection modules.

Illumination module: A fiber-coupled 488 nm continuous-wave laser is collimated by a fiber laser collimator lens (LC) to generate a linearly-polarized collimated Gaussian beam profile. The laser beam inputs to the acoustic optical deflector (AOD) and the AOD deflect the beam at variance of deflection angle to achieve a fast-scanning beam along the laser scanning direction (X direction) up to 400 kHz. The output 1st-order deflection beam is corrected by a cylinder lens (CL) to correct the astigmatism cause by the chirping effect of the AOD. The illumination beam size is then adjusted by a pair of illumination achromatic lenses (IL3 and IL4). The size-adjusted beam passes through a quarter-wave plate (QWP) to modify the polarization angle. The polarization-adjusted illumination beam is reflected by a customized donut mirror (CM1), where the center region is reflecting the illumination beam, and the outer region is transmitting other wavelengths. The reflected illumination beam is adjusted by the second pair of illumination achromatic lenses (IL1 and IL2). The adjusted illumination beam is then focused by a 50× objective lens (IO) to achieve a focused beam spot at the flow cell target plane. The focused beam waist spot size at flow cell plane is 1.5 μm under full-with-half-maximum measurement.

Forward detection module: The forward transmitted and scattered light from the interrogated particle is collected and collimated by a forward detection achromatic lens (FDL1). A beam splitter (BS1) splits the light path. 10% of the light transmits through the BS1 and is focused by a forward detection achromatic lens (FDL2) to form an image at the CMOS camera plane. 90% of the light is reflected by the BS1. The reflected light is optically filtered by a 488/10 nm forward detection filter (FDF1) to only transmit 488 nm laser transmission and forward-scattering light. The filtered light is equally split by the beam splitter (BS2). The reflected light from the BS2 is spatially filtered by the brightfield spatial filter (FSP1) to reject the scattering light. The spatially filtered forward transmitting light is focused by a forward detection achromatic lens (FDL3) on the brightfield photodiode detector plane. The transmitted light from the BS2 is spatially filtered by the darkfield spatial filter (FSP2) to reject the transmitting light. The spatially filtered forward scattering light is focused by a forward detection achromatic lens (FDL4) on the darkfield photodiode detector plane.

Backward detection module: This module shares the IO, IL1, IL2 and CM1 in the illumination module. The backscattered laser light and fluorescent emission from the examined particles is collected by the IO. The IL1 and IL2 adjust the collection beam size. The collection beam is transmitted through the CM1. the transmitted collection beam is the focused by a backward detection achromatic lens (BDL1). The focused collection beam is collected by an optical fiber, which also acts as a spatial filter to reject the light outside of the laser interrogation region. The fiber collected light is then collimated by a backward detection achromatic lens (BDL2). The collimated collection beam is spectrally split by a backward detection dichroic mirror (BDDM1). The reflected light from the BDDM1 is optically filtered by a backward detection filter (BDF1) and the filtered light is projected to a photomultiplier tube (PMT) as the 488 nm backscatter detector. The transmitted light from the BDDM1 is optically filtered by a backward detection filter (BDF2) and the filtered light is projected to a photomultiplier tube (PMT) as the fluorescence detector.

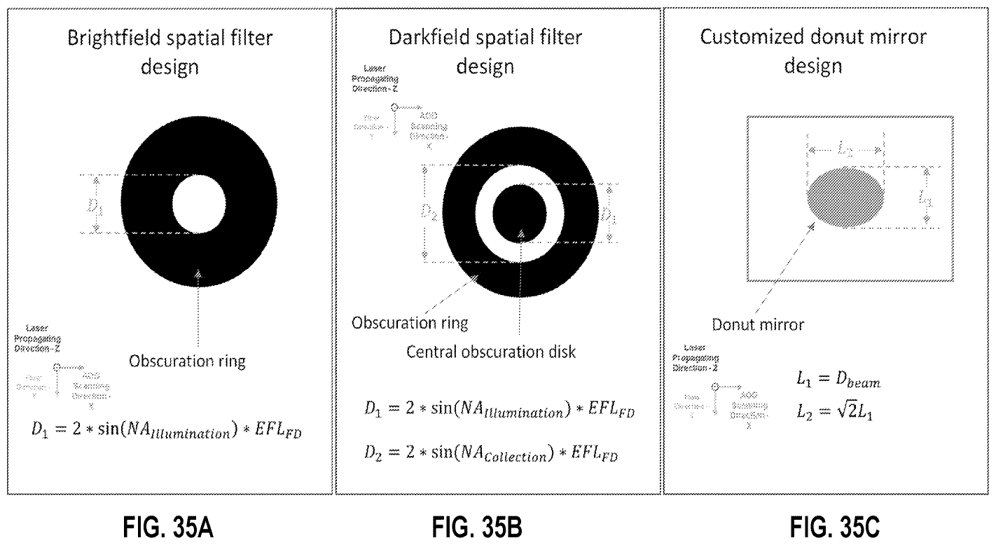

FIGS. 35A-3C provide examples of a brightfield spatial filter design (FIG. 35A), a darkfield special filter design (FIG. 35B), and a customized donut mirror design (FIG. 35C) that may be used with a flow cytometer epi-fluorescence configuration.

FIG. 35A: a schematic of an example brightfield spatial filter design. In this example, the design has an opaque obscuration ring to block any forward scattering light from the examined particle. The aperture diameter (D₁) of the central transparent disk matches the collected illumination laser beam diameter based on the illumination numeric aperture (NA_{Illumination}) and effective focal length (EFL_{FD}) of the forward detection lens (FDL1), as shown for example in FIG. 33.

FIG. 35B: a schematic of an example darkfield spatial filter design. In this example, the design has an opaque central obscuration disk to block any forward transmitted light from the examined particle, and a transparent ring to transmit any forward scattering light from the examined particle. The diameter (D₁) of the central obscuration disk matches the collected illumination laser beam diameter based on the illumination numeric aperture (NA_{Illumination}) and effective focal length (EFL_{FD}) of the forward detection lens (FDL1), as shown for example in FIG. 33. The outer diameter (D₂) of the transparent ring is calculated based on the collection optics numeric aperture (NA_{Collection}) and effective focal length (EFL_{FD}) of the forward detection lens (FDL1), as shown for example in FIG. 33.

FIG. 35C: a schematic of an example customized donut mirror design. In this example, the customized donut mirror is designed to reflect the scanning illumination laser beam by a customized elliptical shape reflective or dichroic coating at the center region of the window. In the meantime, the transparent region of the window transmits the light collected from the backward detection optics. The incident angle of the illumination laser is designed to be 45 degrees. The major (L₂) and minor (L₁) axis of the donut mirror is calculated based on the illumination beam size at the donut mirror plane.

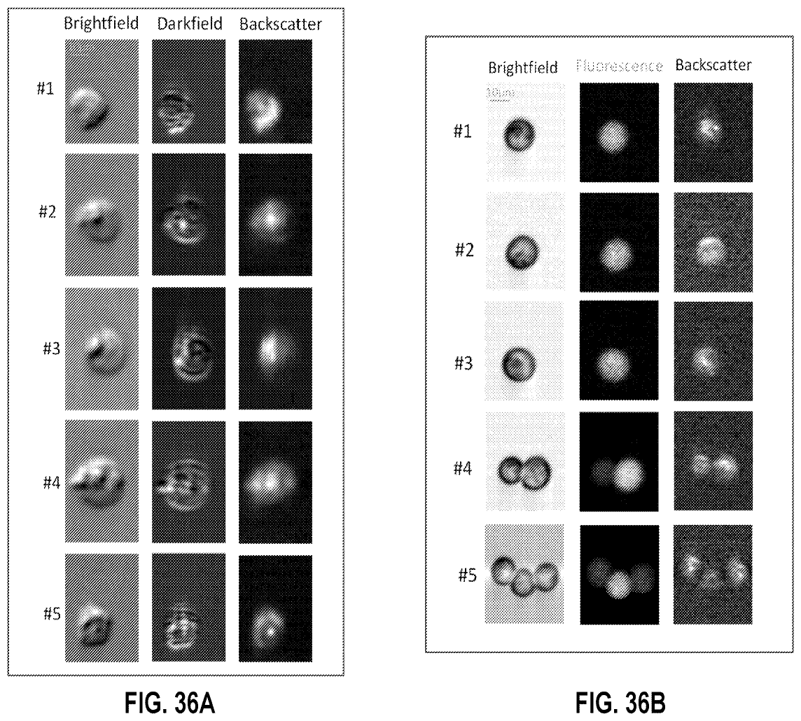

FIG. 36A shows example images of paraformaldehyde fixed human embryotic kidney 293 (HEK-293) cells imaged using the example flow cytometer epi-fluorescence configuration of FIGS. 33 and 34 and with the example filters and mirrors of FIGS. 35A-35C. Brightfield, darkfield and backscatter channels are presented in columns. Scale bar: 10 μm.

FIG. 36B shows example images of green fluorescence protein transfected Chinese hamster ovary (CHO) cells sing the example flow cytometer epi-fluorescence configuration of FIGS. 33 and 34 and with the example filters and mirrors of FIGS. 35A-35C. Brightfield, fluorescence and backscatter channels are presented in columns. Scale bar: 10 μm.

### Enumerated Embodiments

Clause 1. A system for sorting a particle in a sample comprising: (a) a flow cell configured to allow the particle to move in a flow path in a flow direction; (b) a sorting module fluidly connected to the flow cell; (c) an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; (d) a detection module comprising at least one spatial filter, the at least one spatial filter comprising a forward spatial filter and the at least one spatial filter comprises: (i) a front surface; (ii) a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and (e) a data processing module configured to generate a gating signal using the time-dependent signal, and wherein the sorting module is configured to receive the gating signal and sort the particle in response to the gating signal.

Clause 2. The system of clause 1, wherein a plurality of focal planes corresponds to the plurality of apertures.

Clause 3. The system of clause 2, wherein at least a subset of the plurality of focal planes reside within the flow path.

Clause 4. The system of clause 1, wherein the forward spatial filter is configured for transmission detection.

Clause 5. The system of any one of clauses 1-4, wherein each of the plurality of focal planes are orthogonal to the light propagating direction.

Clause 6. The system of any one of clauses 1-5, wherein each of the focal planes are offset to each other along the light propagating direction.

Clause 7. The system of clause 1, wherein the tilting angle of the forward spatial filter, is about 20 degrees to about 60 degrees.

Clause 8. The system of clause 1, wherein the at least one spatial filter comprises a side detection spatial filter.

Clause 9. The system of any one of clauses 1-3 or 8, wherein each of the plurality of focal planes are orthogonal to a secondary light propagating direction and offset to each other along the secondary light propagating direction.

Clause 10. The system of any one of clauses 1-3, 8, or 9, wherein the light propagating direction and the secondary light propagating direction are perpendicular to each other.

Clause 11. The system of any one of clauses 1-3, 8, 9, or 10, wherein the tilting angle of the side spatial filter, J, is about 2 degrees to about 15 degrees.

Clause 12. The system of clause 1, a particle motion device comprising a flow cell, the particle motion device configured to move a sample fluid along the flow path in the flow direction, the flow path surrounded by a sheath flow.

Clause 13. The system of clause 1, wherein the particle comprises a plurality of particles.

Clause 14. The system of clause 1, wherein the particle feature comprises a plurality of particle features.

Clause 15. The system of clause 1, wherein the particle feature comprises a region on or within the particle.

Clause 16. The system of clause 15, wherein the region on or within the particle comprises a plurality of regions on or within the particle.

Clause 17. The system of any one of the preceding clauses, wherein a first particle feature of the plurality of particle features comprises a first region of the plurality of regions on or within the particle.

Clause 18. The system of any one of the preceding clauses, wherein a second particle feature of the plurality of particle features comprises a second region of the plurality of regions on or within the particle.

Clause 19. The system of any one of the preceding clauses, wherein the time-dependent signal comprises a plurality of time-dependent signal features.

Clause 20. The system of any one of the preceding clauses, wherein the time-dependent signal comprises a first time-dependent signal feature of the plurality.

Clause 21. The system of any one of the preceding clauses, wherein the time-dependent signal comprises a second time-dependent signal feature of the plurality.

Clause 22. The system of any one of the preceding clauses, wherein the first time-dependent signal feature correlates to the first particle feature, the second particle feature or a combination thereof.

Clause 23. The system of any one of the preceding clauses, wherein the second time-dependent signal feature correlates to the first particle feature, the second particle feature or a combination thereof.

Clause 24. The system of any one of the preceding clauses, wherein the particle comprises a cell.

Clause 25. The system of any one of the preceding clauses, wherein the particle feature comprises an organelle, a partial organelle, or a plurality of organelles of the cell.

Clause 26. The system of any one of the preceding clauses, wherein the cell is a gamma radiation damaged cell with histone related staining.

Clause 27. The system of any one of the preceding clauses, wherein the light redirecting device comprises an acoustic optical deflector.

Clause 28. The system of any one of the preceding clauses, wherein the illumination module further comprises a light source, an excitation filter, a cylindrical lens, or a combination thereof.

Clause 29. The system of any one of the preceding clauses, wherein the light source, the cylindrical lens and the flow cell are offset along the light propagating direction, wherein the cylindrical lens is positioned between the light source and the flow cell.

Clause 30. The system of any one of the preceding clauses, wherein the light source comprises a plurality of light sources.

Clause 31. The system of any one of the preceding clauses, wherein the cylindrical lens and the flow cell are offset along the light propagating direction.

Clause 32. The system of any one of the preceding clauses, wherein the cylindrical lens is configured to elongate the light beam within the plane comprising the scanning direction and the flow direction, the elongated light beam comprising a light sheet.

Clause 33. The system of any one of the preceding clauses, wherein the scan comprises a plurality of light sheet positions offset along the light propagating direction.

Clause 34. The system of any one of the preceding clauses, wherein the time-dependent signal comprises a plurality of time-dependent signals.

Clause 35. The system of any one of the preceding clauses, wherein the time-dependent signal comprises at least one aperture-line-scan-time-dependent signal.

Clause 36. The system of any one of the preceding clauses, wherein the aperture-line-scan-time-dependent signal comprises a light-intensity-time point.

Clause 37. The system of any one of the preceding clauses, wherein the at least one aperture-line-scan-time-dependent signal is acquired via a single aperture.

Clause 38. The system of any one of the preceding clauses, wherein the aperture-line-scan-time-dependent signal comprises a 1-dimensional (1D) profile of the particle.

Clause 39. The system of any one of the preceding clauses, wherein the time-dependent signal comprises a 2D profile of the particle.

Clause 40. The system of any one of the preceding clauses, wherein the time-dependent signal comprises a 3D profile of the particle.

Clause 41. The system of any one of the preceding clauses, wherein the at least one light source comprises at least one laser, or at least one broadband light source, or a combination thereof.

Clause 42. The system of any one of the preceding clauses, wherein the at least one laser comprises a wavelength of about 488 nanometers.

Clause 43. The system of any one of the preceding clauses, wherein the broadband light source may comprise a halogen source, a Xenon source, light emitting diode (LED) source, or a combination thereof.

Clause 44. The system of any one of the preceding clauses, the detector comprises a plurality of detectors.

Clause 45. The system of any one of the preceding clauses, wherein the detector comprises a PMT, APD, CCD, or photodiode detector.

Clause 46. The system of any one of the preceding clauses, wherein the time-dependent signal comprises data correlating to the different features of the particle in relation to 3D space.

Clause 47. The system of any one of the preceding clauses, wherein the data processing module is configured to generate 2D image slices of the particle, the 2D image comprising the different features of the particle.

Clause 48. The system of any one of the preceding clauses, wherein the data processing module is configured to generate a 3D image of the particle, the 3D image comprising the different features of the particle.

Clause 49. The system of any one of the preceding clauses, wherein the spatial filter is an optical fiber bundle comprising a plurality of optical fibers.

Clause 50. The system of any one of the preceding clauses, wherein the aperture comprises a core of an optical fiber of an optical fiber bundle.

Clause 51. The system of any one of the preceding clauses, wherein the flow cell comprises quartz.

Clause 52. The system of any one of the preceding clauses, wherein the flow cell exhibits a low autofluorescence.

Clause 53. The system of any one of the preceding clauses, further comprising a dielectric mirror configured to elongate the laser beam.

Clause 54. The system of any one of the preceding clauses, wherein the detection module comprises a focal depth of about 5 microns to about 70 microns.

Clause 55. The system of any one of the preceding clauses, wherein the detection module comprises a focal depth of about 100 microns.

Clause 56. The system of any one of the preceding clauses, wherein at least the illumination module, the detection module, the data processing module, or a combination thereof is configured for forward (e.g., transmission) detection.

Clause 57. The system of any one of the preceding clauses, wherein at least the illumination module, the detection module, the data processing module, or a combination thereof is configured for side detection.

Clause 58. The system of any one of the preceding clauses, wherein at least the illumination module, the detection module, the data processing module, or a combination thereof is configured for fluorescence detection.

Clause 59. The system of any one of the preceding clauses, wherein the flow cell comprises an outer surface, wherein the outer surface comprises at least one region that is orthogonal to light scattered by the particle.

Clause 60. The system of any one of the preceding clauses, the side scatter detector is configured to detect the light scattered by the particle at a side scatter detection angle from about 70 degrees to about 110 degrees.

Clause 61. The system of any one of the preceding clauses, wherein the flow cell comprises a cross fitting configured to generate the sheath flow.

Clause 62. The system of any one of the preceding clauses, wherein the flow cell is configured for 2D hydrodynamic focusing.

Clause 63. The system of any one of the preceding clauses, wherein the flow cell comprises an inner diameter of about 200 microns.

Clause 64. The system of any one of the preceding clauses, wherein the flow cell comprises a cone tapered end.

Clause 65. The system of any one of the preceding clauses, wherein the cone tapered end has an inner diameter of about 250 microns.

Clause 66. The system of any one of the preceding clauses, wherein the illumination module comprises a digitizer.

Clause 67. The system of any one of the preceding clauses, wherein the illumination module comprises 12 output channels.

Clause 68. The system of any one of the preceding clauses, wherein the 12 output channels comprise 11 PMT channels and 1 AOD channel.

Clause 69. The system of any one of the preceding clauses, wherein data is transmitted with a field programmable gate array (FPGA) into PXIe-BUS.

Clause 70. The system of any one of the preceding clauses, wherein the data processing module comprises a data processing pipeline, the pipeline configured to: (a) obtain time-dependent data; (b) parse time-dependent data; (c) generate intensity statistics; and (d) determine a gating.

Clause 71. The system of any one of the preceding clauses, wherein the sorting module is configured for jet-in-air sorting.

Clause 72. The system of any one of the preceding clauses, wherein the sorting module is configured for laser cavitation sorting.

Clause 73. The system of any one of the preceding clauses, wherein the system is configured to sort at least about 10-4 seconds after the detection of the particle.

Clause 74. The system of any one of the preceding clauses, wherein the system is configured to sort from about 10-4 seconds to about 10-1 seconds after the detection of the particle.

Clause 75. The system of any one of the preceding clauses, wherein the detection module is configured for imaging flow cytometry.

Clause 76. The system of any one of the preceding clauses, wherein the detection module is configured for three-dimensional imaging flow cytometry.

Clause 77. The system of any one of the preceding clauses, wherein the detection module is configured for two-dimensional transmission imaging flow cytometry.

Clause 78. The system of any one of the preceding clauses, further comprising at least two output channels, each output channel fluidly connected to the sorting module, wherein the sorting module is configured to receive the gating signal and sort the particle, into one of the at least two output channels.

Clause 79. The system of any one of the preceding clauses, wherein the illumination module comprising a light redirection device configured to scan a light beam in a scanning direction, wherein the scanning direction is within about to a perpendicular orientation with the flow direction, and wherein the light beam is propagated in a light propagating direction within about to an orthogonal orientation to a plane comprising the flow direction and the scanning direction.

Clause 80. The system of any one of the preceding clauses, wherein the system is configured for backward detection.

Clause 81. The system of clause 80, comprising a backward detection module.

Clause 82. The system of any one of the preceding clauses, wherein the backward detection module comprises a spatial filter.

Clause 83. The system of any one of the preceding clauses, further comprising a backward scattering image modality.

Clause 84. The system of any one of the preceding clauses, further comprising a donut mirror.

Clause 85. The system of clause 84, wherein the donut mirror is configured to accommodate epi-fluorescence detection for scanning laser illumination.

Clause 86. A method for particle sorting, the method comprising: (a) providing a sorting system comprising: (i) a flow cell configured to allow a particle to move in a flow path in a flow direction; (ii) a sorting module fluidly connected to the flow cell; (iii) an illumination module comprising a light redirection device configured to scan a light beam in a scanning direction, wherein the scanning direction is about perpendicular to the flow direction, and wherein the light beam is propagated in a light propagating direction about orthogonal to a plane comprising the flow direction and the scanning direction; (iv) a detection module comprising a spatial filter, the spatial filter comprising: a front surface; a plurality of apertures, the plurality of apertures arranged in a line comprising a tilting angle with the flow direction, wherein the detection module is configured to generate a time-dependent signal upon detection of the particle within the flow path, wherein the time-dependent signal correlates to a particle feature of the particle; and (v) a data processing module configured to generate a gating signal using the time-dependent signal; and (b) loading a sample comprising the plurality of particles into the system; and (c) initiating the system, and wherein, the sorting module is configured to sort the particle in response the gating signal.

Clause 87. A method for cell sorting, the method comprising: (a) flowing a particle along a flow path through a flow cell in a flow direction; (b) illuminating the particle via scanning a light beam in a scanning direction, the scanning direction about perpendicular to the flow direction, the light beam propagating in a light propagating direction about orthogonal to a plane comprising the flow direction and the scanning direction; (c) detecting the particle, wherein light having interacted with the particle transmits through an aperture of a plurality of apertures of a spatial filter, the plurality of apertures arranged in a line comprising a tilting angle with the flow direction, wherein the detection module is configured to generate a time-dependent signal upon detection of the particle, wherein the time-dependent signal correlates to a particle feature of the particle; (d) generating a gating signal based on aspects of the particle feature; and (e) sorting the particle based on the gating signal.

Clause 88. An automated data processing method for flow cytometry gating, the method comprising: (a) obtaining a time-dependent signal; (b) generating intensity statistics; and (c) determining a gating signal.

Clause 89. The method of clause 88, further comprising parsing time-dependent signal.

Clause 90. A method for cell sorting, the method comprising: a) flowing a particle along a flow path through a flow cell in a flow direction; b) illuminating the particle via scanning a light beam in a scanning direction, the scanning direction about perpendicular to the flow direction, the light beam propagating in a light propagating direction about orthogonal to a plane comprising the flow direction and the scanning direction; c) detecting the particle, wherein light being diffracted by the particle in a diffracted direction at a diffracted angle from the propagating direction transmits through an aperture of a spatial filter, the aperture arranged in a position of the diffracted direction, wherein the detection module is configured to generate a time-dependent signal upon detection of the particle, wherein the time-dependent signal correlates to a particle feature of the particle; d) generating a gating signal based on aspects of the particle feature; and e) sorting the particle based on the gating signal.

1. A system for sorting a particle in a sample comprising:
a) a flow cell configured to allow the particle to move in a flow path in a flow direction;
b) a sorting module fluidly connected to the flow cell;
c) an illumination module comprising a light redirection device configured to diffract or scan a light beam in a scanning direction, wherein the scanning direction is about perpendicular to the flow direction, and wherein the light beam is propagated in a light propagating direction about orthogonal to a plane comprising the flow direction and the light beam diffraction or scan direction;
d) a detection module comprising at least one spatial filter, the at least one spatial filter comprising a forward spatial filter and the at least one spatial filter comprises:
i. a front surface;
ii. a plurality of apertures, the plurality of apertures arranged in a line comprising an angle with the flow direction, wherein the detection module is configured to generate a time-dependent signal upon detection of the particle within the flow path, wherein the time-dependent signal correlates to a particle feature of the particle; and
e) a data processing module configured to generate a gating signal using the time-dependent signal, and
wherein the sorting module is configured to receive the gating signal and sort the particle in response to the gating signal.

2. The system of claim 1, wherein a plurality of focal planes corresponds to the plurality of apertures.

3. The system of claim 2, wherein at least a subset of the plurality of focal planes resides within the flow path.

4. The system of claim 1, wherein the forward spatial filter is configured for transmission detection.

5. The system of claim 1, wherein each of the plurality of focal planes is orthogonal to the light propagating direction.

6. The system of claim 1, wherein each of the plurality of focal planes is offset to each other along the light propagating direction.

7. (canceled)

8. The system of claim 1, wherein the at least one spatial filter comprises a side detection spatial filter.

9. The system of claim 1, wherein each of the plurality of focal planes are orthogonal to a secondary light propagating direction and offset to each other along the secondary light propagating direction.

10. The system of claim 1, wherein the light propagating direction and the secondary light propagating direction are perpendicular to each other.

11. The system of claim 1, wherein the angle of the side spatial filter, ϑ, is about 2 degrees to about 15 degrees.

12. The system of claim 1, a particle motion device comprising a flow cell, the particle motion device configured to move a sample fluid along the flow path in the flow direction, the flow path surrounded by a sheath flow.

13. The system of claim 1, wherein the particle comprises a plurality of particles.

14. The system of claim 1, wherein the particle feature comprises a plurality of particle features.

15. The system of claim 1, wherein the particle feature comprises a region on or within the particle.

16. The system of claim 15, wherein the region on or within the particle comprises a plurality of regions on or within the particle.

17.-26. (canceled)

27. The system of claim 1, wherein the light redirecting device comprises an acoustic optical deflector.

28.-31. (canceled)

32. The system of claim 1, wherein the light redirection device configured to scan or diffract a plurality of light sheet positions offset along the light propagating direction.

33.-45. (canceled)

46. A method for particle sorting, the method comprising:
a) providing a sorting system comprising:
i) a flow cell configured to allow a particle to move in a flow path in a flow direction;
ii) a sorting module fluidly connected to the flow cell;
iii) an illumination module comprising a light redirection device configured to diffract or scan a light beam in a diffraction or scan direction, wherein the diffraction or scan direction is about perpendicular to the flow direction, and wherein the light beam is propagated in a light propagating direction about orthogonal to a plane comprising the flow direction and the diffraction or scan direction;
iv) a detection module comprising a spatial filter, the spatial filter comprising:
1. a front surface;
2. a plurality of apertures, the plurality of apertures arranged in a line comprising an angle with the flow direction, wherein the detection module is configured to generate a time-dependent signal upon detection of the particle within the flow path, wherein the time-dependent signal correlates to a particle feature of the particle; and
v) a data processing module configured to generate a gating signal using the time-dependent signal; and
b) loading a sample comprising the plurality of particles into the system; and
c) initiating the system, and
wherein, the sorting module is configured to sort the particle in response the gating signal.

47. A method for cell sorting, the method comprising:
a) flowing a particle along a flow path through a flow cell in a flow direction;
b) illuminating the particle via diffracting or scanning a light beam in a diffraction or scan direction, the diffraction or scan direction about perpendicular to the flow direction, the light beam propagating in a light propagating direction about orthogonal to a plane comprising the flow direction and the diffraction or scan direction;
c) detecting the particle, wherein light having interacted with the particle transmits through an aperture of a plurality of apertures of a spatial filter, the plurality of apertures arranged in a line comprising an angle with the flow direction, wherein the detection module is configured to generate a time-dependent signal upon detection of the particle, wherein the time-dependent signal correlates to a particle feature of the particle;
d) generating a gating signal based on aspects of the particle feature; and
e) sorting the particle based on the gating signal.

48. (canceled)

49. (canceled)

50. (canceled)
